(19) United States
(12) Patent Application Publication
(10) Pub. No.: US 2016/0164784 A1
(43) Pub. Date: Jun. 9, 2016

(54) DATA TRANSMISSION METHOD AND APPARATUS

(71) Applicant: FUJITSU LIMITED, Kawasaki-shi (JP)

(72) Inventor: Kouichirou AMEMIYA, Kawasaki (JP)

(73) Assignee: FUJITSU LIMITED, Kawasaki-shi (JP)

(21) Appl. No.: 14/957,729

(22) Filed: Dec. 3, 2015

(30) Foreign Application Priority Data
Dec. 8, 2014 (JP) 2014-248407

(51) Int. Cl. H04L 12/801; H04L 12/825

(52) U.S. Cl. CPC H04L 47/12; H04L 47/25

(57) ABSTRACT

A disclosed data transmission method includes; detecting that congestion has occurred in a network between the first information processing apparatus and a second information processing apparatus that is a transmission destination of one or more data blocks; identifying a first data block that satisfies a condition that a time period from a transmission time to a time limit of delivery is longer than a predetermined time period, based on data stored in a data storage unit that stores a transmission time and a time limit of delivery for each of the one or more data blocks; transmitting, to the second information processing apparatus, a request that includes a time limit of delivery of the first data block and requests to reset a transmission time of the first data block; and receiving, from the second information processing apparatus, a transmission time that is set by the second information processing apparatus.

### CROSS-REFERENCE TO RELATED APPLICATIONS

This application is based upon and claims the benefit of priority of the prior Japanese Patent Application No. 2014-248407, filed on Dec. 8, 2014, the entire contents of which are incorporated herein by reference.

### FIELD

This invention relates to a scheduling technique of data transmission among nodes.

### BACKGROUND

A system that delivers an appropriate advertisement according to properties of a user and/or a situation (e.g. a system for a behavioral targeting advertising) is known. This system determines a recommended advertisement according to a taste (e.g. purchase history) of a user and/or a situation (e.g. temperature), and displays it on a display and the like installed on a street.

Such a system is based on a premise that information related to a user is delivered to a place at which the display and the like have been installed, before the user arrives at that place. However, if the information is delivered long before the user arrives at that place, capacity of a storage device at that place is consumed for long periods of time. Therefore, it is not always good to deliver the information early.

As for the service as described above, a certain document discloses the following technique. Specifically, a time to transmit content to a transmission destination apparatus (hereinafter, referred to as a transmission time) is calculated for each kind of content, and a transmission schedule is managed based on transmission times of the content. Thus, it becomes possible to deliver the content before users arrive.

However, in the technique described above, when transmission times of the plural kinds of content are concentrated in a specific time slot, congestion occurs in a network and it becomes impossible to deliver the plural kinds of content by their target times.

Such a problem of the congestion is not sufficiently investigated also in other documents.

Patent Document 1: International Publication Pamphlet No. WO 2011/102294

Patent Document 2: Japanese Laid-open Patent Publication No. 8-88642

Patent Document 3: Japanese Laid-open Patent Publication No. 2013-254311

In other words, there is no technique to suppress delay of data transmission.

### SUMMARY

A data transmission method relating to this invention includes: detecting that congestion has occurred in a network between the first information processing apparatus and a second information processing apparatus that is a transmission destination of one or more data blocks; first identifying a first data block that satisfies a condition that a time period from a transmission time to a time limit of delivery is longer than a predetermined time period, based on data stored in a data storage unit that stores a transmission time and a time limit of delivery for each of the one or more data blocks; first transmitting, to the second information processing apparatus, a first request that includes a time limit of delivery of the first data block and requests to reset a transmission time of the first data block; and first receiving, from the second information processing apparatus, a transmission time that is set by the second information processing apparatus.

The object and advantages of the embodiment will be realized and attained by means of the elements and combinations particularly pointed out in the claims.

It is to be understood that both the foregoing general description and the following detailed description are exemplary and explanatory and are not restrictive of the embodiment, as claimed.

### BRIEF DESCRIPTION OF DRAWINGS

FIG. 1 is a diagram depicting an outline of a system relating to a first embodiment;

FIG. 2 is a diagram to explain variables relating to the first embodiment and the like;

FIG. 3 is a diagram to explain time slots relating to the first embodiment;

FIG. 4A is a diagram to explain a processing outline of the first embodiment;

FIG. 4B is a diagram to explain the processing outline of the first embodiment;

FIG. 4C is a diagram to explain the processing outline of the first embodiment:

FIG. 4D is a diagram to explain the processing outline of the first embodiment;

FIG. 4E is a diagram to explain the processing outline of the first embodiment;

FIG. 4F is a diagram to explain the processing outline of the first embodiment;

FIG. 4G is a diagram to explain the processing outline of the first embodiment;

FIG. 5 is a diagram depicting a configuration example of a node relating to the first embodiment;

FIG. 6 is a diagram depicting a format example of a message received by the node relating to the first embodiment;

FIG. 7 is a diagram depicting a format example of the message received by the node relating to the first embodiment;

FIG. 8 is a diagram depicting a format example of data stored in a latency data storage unit;

FIG. 9 is a diagram depicting a format example of data stored in a link data storage unit;

FIG. 10 is a diagram depicting a format example of data stored in a data transfer route storage unit;

FIG. 11A is a diagram depicting a data structure example of a data queue;

FIG. 11B is a diagram depicting the data structure example of the data queue;

FIG. 12 is a diagram depicting a format example of data stored in a resource management data storage unit;

FIG. 13 is a diagram depicting a format example of data stored in the resource management data storage unit;

FIG. 14 is a diagram depicting a format example of data stored in a scheduling data storage unit;

FIG. 15 is a diagram depicting a processing flow when receiving data, which is relating to the first embodiment;

FIG. 16 is a diagram depicting a processing flow of processing executed by a schedule negotiator;

FIG. 17 is a diagram depicting a data format example of a scheduling request;

FIG. 18 is a diagram depicting an example of the scheduling request in the JSON format;

FIG. 19 is a diagram depicting a processing flow of processing executed by the schedule negotiator;

FIG. 20 is a diagram depicting a processing flow of processing executed by a data transmitter;

FIG. 21 is a diagram depicting a processing flow of processing executed by a second scheduler;

FIG. 22 is a diagram to explain processing details of a scheduling processing unit;

FIG. 23 is a diagram depicting a processing flow of processing executed by the second scheduler;

FIG. 24 is a diagram to explain sorting of messages;

FIG. 25 is a diagram to explain sorting of messages;

FIG. 26 is a diagram depicting a processing flow of processing executed by the second scheduler;

FIG. 27 is a diagram depicting a processing flow of processing executed by the second scheduler;

FIG. 28 is a diagram to explain sorting of messages;

FIG. 29 is a diagram depicting processing flow of processing executed by a monitoring unit in the first embodiment;

FIG. 30 is a diagram depicting a processing flow of congestion avoidance processing in the first embodiment;

FIG. 31 is a diagram depicting a processing flow of processing executed by a third scheduler;

FIG. 32 is a diagram depicting a configuration example of a node in the second embodiment;

FIG. 33 is a diagram depicting an example of data stored in a second latency data storage unit;

FIG. 34 is a diagram depicting a processing flow of processing executed by the monitoring unit in the second embodiment;

FIG. 35 is a diagram depicting an outline of a system relating to a third embodiment;

FIG. 36 is a diagram depicting a configuration example of a node relating to the third embodiment;

FIG. 37 is a diagram depicting an example of data stored in a priority storage unit;

FIG. 38 is a diagram depicting an example of data stored in an adjacent node data storage unit;

FIG. 39 is a diagram depicting an example of a format of a message for exchanging information on a degree of priority;

FIG. 40 is a diagram depicting an example of a format of a message for notifying detection of congestion;

FIG. 41 is a diagram depicting a processing flow of processing executed by a priority management unit;

FIG. 42 is a diagram depicting a processing flow of processing executed by the priority management unit;

FIG. 43A is a diagram to explain exchange of degrees of priority;

FIG. 43B is a diagram to explain exchange of the degrees of priority;

FIG. 44 is a diagram depicting a processing flow of the congestion avoidance processing in the third embodiment;

FIG. 45 is a diagram depicting a processing flow of the congestion avoidance processing in the third embodiment;

FIG. 46 is a diagram depicting a configuration example of a node relating to a fourth embodiment;

FIG. 47 is a diagram depicting an example of data stored in a third latency data storage unit;

FIG. 48 is a diagram depicting a processing flow of processing executed by the second scheduler in the third embodiment;

FIG. 49 is a diagram depicting a processing flow of processing executed by the second scheduler in the third embodiment;

FIG. 50A is a diagram to explain processing details of the second scheduler;

FIG. 50B is a diagram to explain the processing details of the second scheduler;

FIG. 51 is a diagram depicting a configuration example of a node relating to a fifth embodiment;

FIG. 52 is a diagram depicting an example of data stored in a related data storage unit;

FIG. 53 is a diagram depicting a processing flow of congestion avoidance processing in a fifth embodiment; and

FIG. 54 is a functional block diagram of a computer.

### DESCRIPTION OF EMBODIMENTS

### Embodiment 1

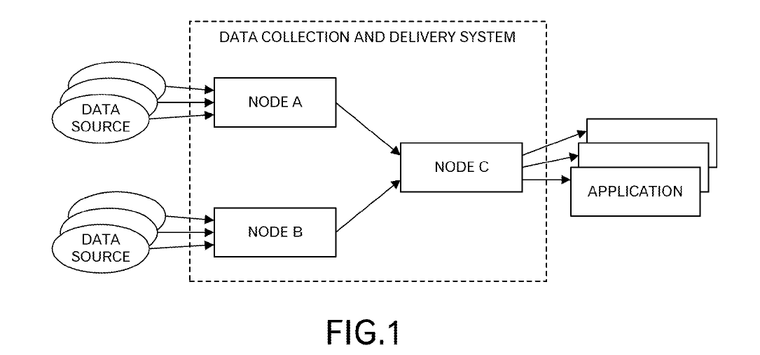

FIG. 1 illustrates an outline of a system relating to a first embodiment of this invention. A data collection and delivery system in FIG. 1 includes plural nodes A to C. The nodes A and B receive data from a data source such as a sensor, and transmit the received data to the node C. The node C outputs the received data to one or more applications that process the data.

The number of nodes included in the data collection and delivery system relating to this embodiment is not limited to “3”, and the number of stages of nodes provided between the data source and the application is not limited to “2”, and may be 2 or more. In other words, in this embodiment, nodes are connected so that plural stages of the nodes are made.

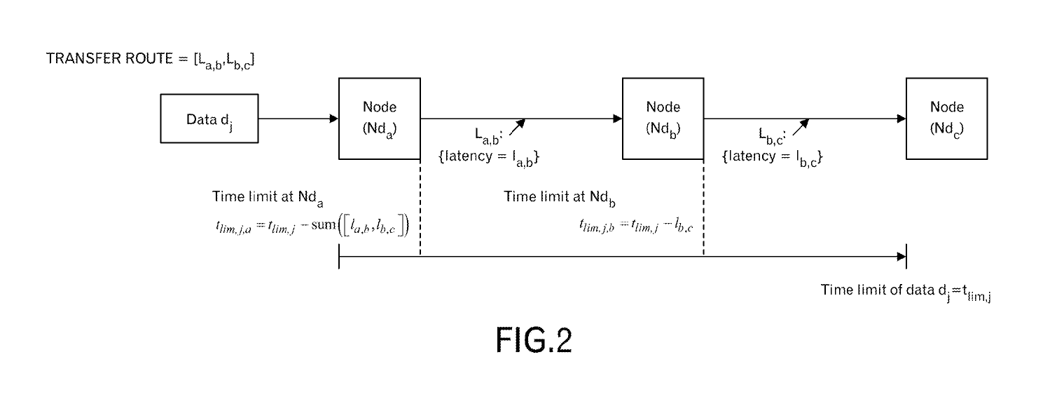

Here, definition of variables that will be used later is explained. In order to make it easy to understand the explanation, as illustrated in FIG. 2, the three-stage configuration of the nodes Ndₐ to Nd_{c} is employed.

As illustrated in FIG. 2, a link L_{a,b} is provided between the node Ndₐ and the node Nd_{b}, and a link L_{b,c} is provided between the node Nd_{b} and the node Nd_{c}. Moreover, data transfer latency of the link L_{a,b} is represented as “l_{a,b}”, and data transfer latency of the link L_{b,c} is represented as “l_{b,c}”.

At this time when a transfer route of data dⱼ (whose data size is represented as sⱼ byte) is [L_{a,b}, L_{b,c}], a time limit (also called as “an arrival time limit” or “a delivery time limit”) of the end-to-end from the node Ndₐ to the node Nd_{c} is represented as “t_{lim,j}” in this embodiment. Moreover, the delivery time limit t_{lim,j,a} of the data dⱼ at the node Ndₐ is “t_{lim,j}−sum([l_{a,b}, l_{b,c}])” (“sum” represents the total sum.). Similarly, the delivery time limit t_{lim,j,b} of the data dⱼ at the node Nd_{b} is “t_{lim,j}−l_{b,c}”.

The bandwidth (bit per second (bps)) of the link L_{a,b} is represented as c_{a,b}.

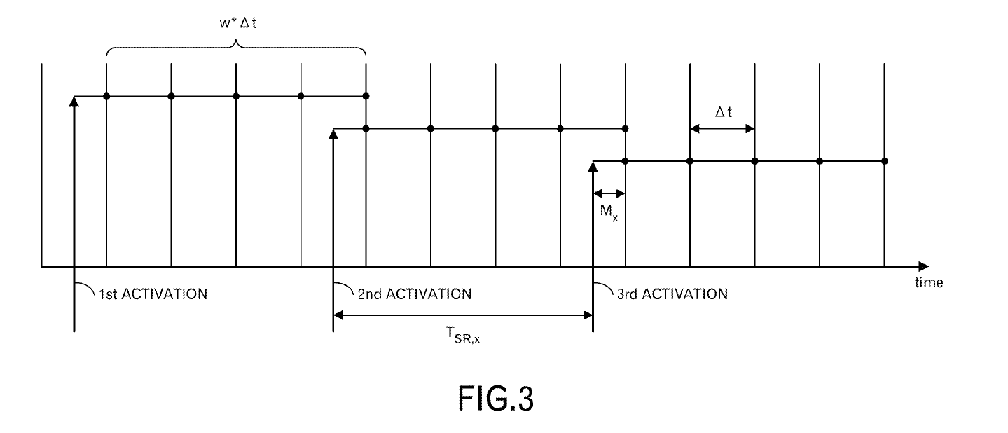

In addition, time slots that will be described below are explained by using FIG. 3. The width of a time slot is represented by Δt, and the i-th time slot is represented as “tᵢ”. Moreover, when the number of time slots that are scheduled once is represented as “w”, the width of the scheduling (i.e. scheduling window) becomes wΔt. A cycle of processing to send a scheduling request in the node Ndₓ (the interval between the first activation and the second activation, and the interval between the second activation and the third activation) is represented as “T_{SR,x}”, and a difference between the activation of the processing to send the scheduling request and the beginning time of the scheduling window to be scheduled is represented as “Mₓ” in this embodiment. A cycle of processing on a side that processes the scheduling request at the node Ndₓ is represented as “T_{TLS-inter,x}” in this embodiment.

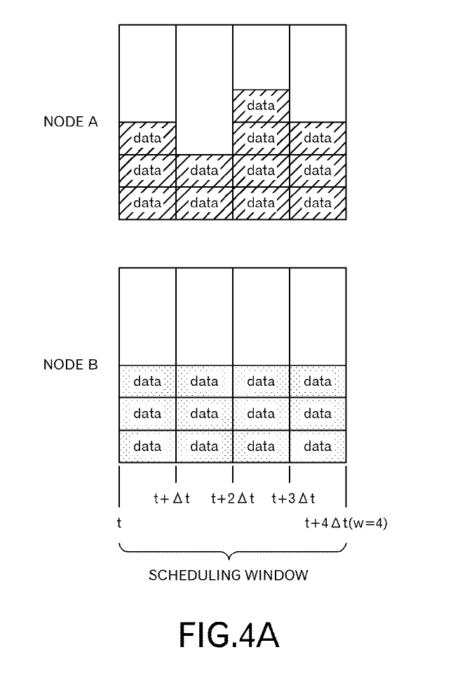

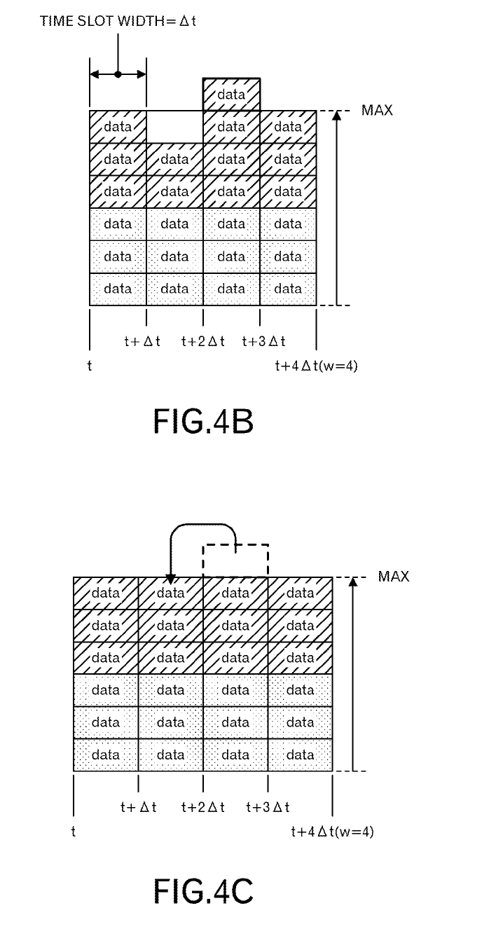

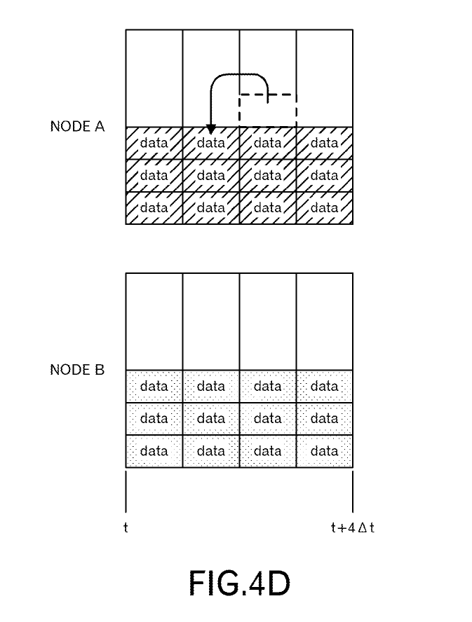

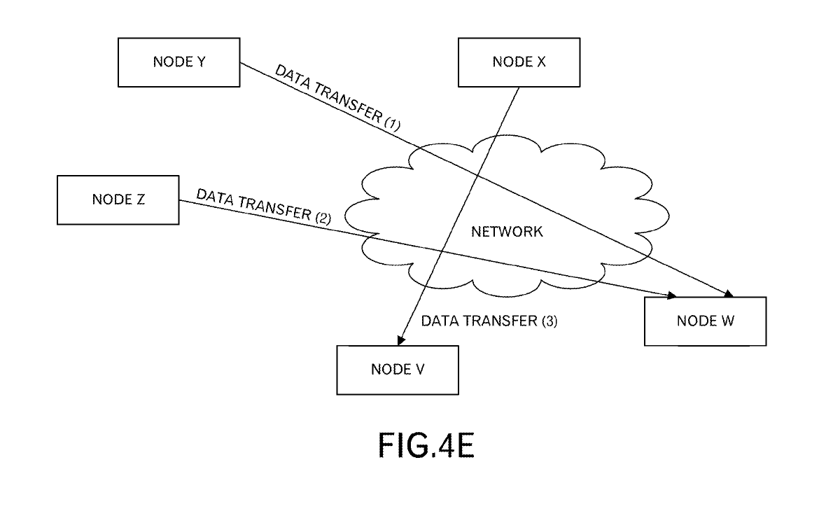

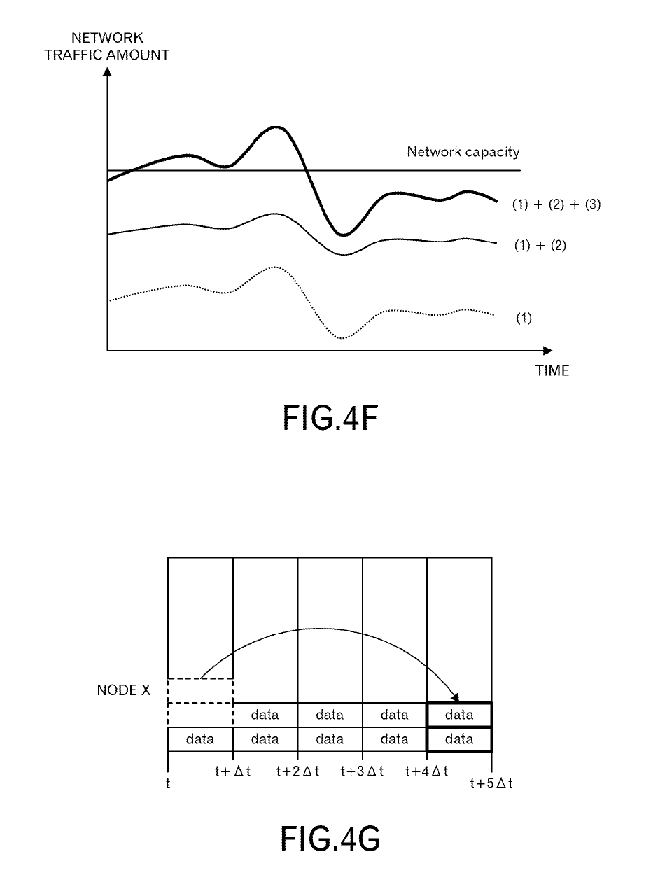

In this embodiment, as illustrated in FIG. 4A, a transmission schedule at the node A and a transmission schedule at the node B are transmitted to the node C. The transmission schedule includes information concerning data to be transmitted in each slot within the scheduling window (here, w=4). Specifically, the transmission schedule includes the delivery time limit t_{lim,j} up to the destination and the transmission time limit t_{lim,j,x} at the node of the transmission source. FIG. 4A depicts data allocated to each of 4 time slots like a block, and hereinafter, a mass of data is called as “a data block” in this embodiment.

When the node C receives the transmission schedule from the nodes A and B, the node C superimposes the transmission schedule as illustrated in FIG. 4B to determine whether or not the size of data to be transmitted is within reception resources of the node C in each time slot. In an example of FIG. 4B, 6 data blocks can be received in one time slot. Therefore, in the third time slot, it can be understood that one data block cannot be received. Then, the data blocks allocated to the third time slot are sorted by t_{lim,j,x} and t_{lim,j} to give the data blocks their degrees of priority. The node C selects a data block based on the degrees of priority, and reallocates the selected data block to another time slot. Specifically, as illustrated in FIG. 4C, the node C allocates the selected data block to a time slot, which has a vacant receiving recourse, immediately before the third time slot. Then, the node C sends back such a scheduling result to the nodes A and B. As illustrated in FIG. 4D, the scheduling result of the node B is the same as the original transmission schedule, however, the scheduling result of the node A is different in the second time slot and the third time slot. The nodes A and B transmit data blocks according to such scheduling results.

Furthermore, in this embodiment, an appropriate scheduling is performed when congestion occurs. For example, a system as illustrated in FIG. 4E is considered. In FIG. 4E, nodes V to Z are connected to a network, the node X transfers data to the node V through the network, and the nodes Y and Z transfer data to the node W through the network. Data transfer performed by the node Y is called data transfer (1), data transfer performed by the node Z is called data transfer (2), and data transfer performed by the node X is called data transfer (3).

FIG. 4F illustrates a network traffic amount of the system illustrated in FIG. 4E. In FIG. 4F, a vertical axis represents a network traffic amount, and a horizontal axis represents time. A dotted line represents a network traffic amount of the data transfer (1), a solid line represents a sum of network traffic amounts of the data transfer (1) and (2), and a thick line represents a sum of network traffic amounts of the data transfer (1), (2) and (3). Network Capacity represents data amount that can be transferred without delay, and congestion is occurring when a network traffic amount exceeds the Network Capacity. As illustrated in FIG. 4F, congestion temporarily occurs when the data transfer (1), (2), and (3) are performed. It is impossible to deliver, to a transmission destination, transmitted data without delay while congestion is occurring.

Therefore, in this embodiment, it is possible to transmit data without congestion by delaying transmission of a part of data blocks when congestion occurred. Scheduling for avoiding congestion is explained by using FIG. 4G. For example, assume that congestion occurs in between time t and time t+Δt. In such a case, the node X requests the node V to reschedule. Then, as illustrated in FIG. 4G, the node V changes a schedule so as to transmit two data blocks in between time t+4Δt and time t+5Δt. Here, the schedule is changed so as to set a time after t+5Δt as a transmission time limit for the two data blocks and to enable to deliver the two data blocks by a delivery time limit. Accordingly, it becomes possible to transmit data blocks so as to avoid congestion and expiration of a delivery time limit.

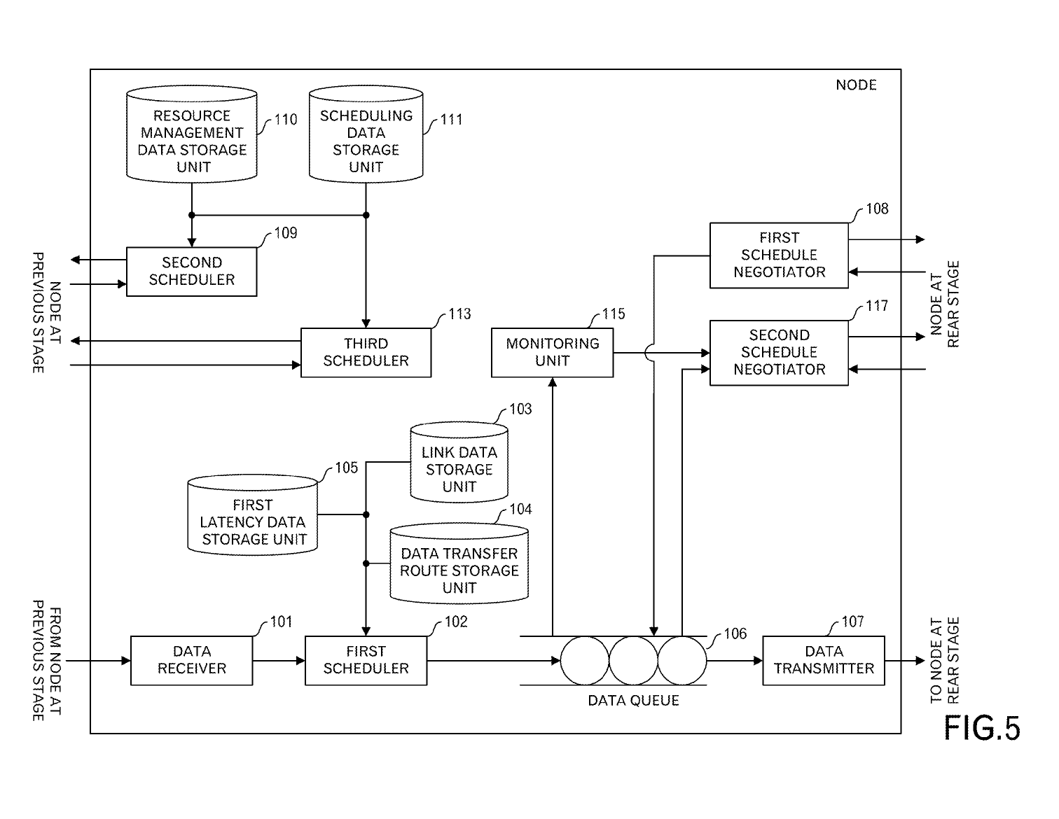

Next, FIG. 5 illustrates a configuration example of each of the nodes A to C to perform the processing as described above. The node has a data receiver 101, a first scheduler 102, a link data storage unit 103, a data transfer route storage unit 104, a first latency data storage unit 105, a data queue 106, a data transmitter 107, a first schedule negotiator 108, a second scheduler 109, a resource management data storage unit 110, a scheduling data storage unit 111, a third scheduler 113, a monitoring unit 115, and a second schedule negotiator 117.

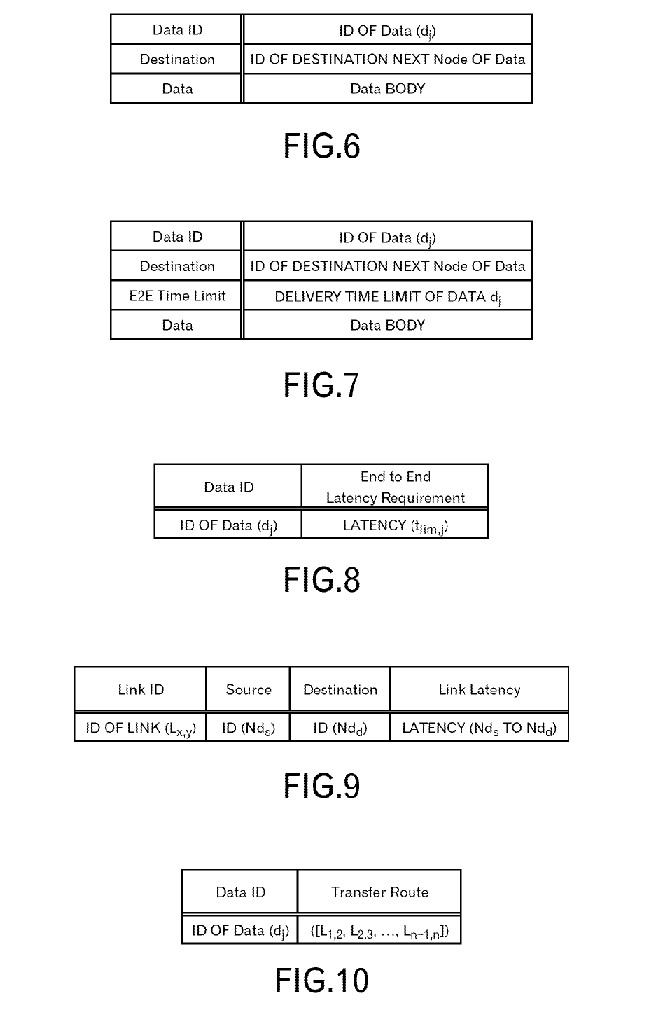

The data receiver 101 receives messages from other nodes or data sources. When the node itself performs processing for data included in the message, a previous stage of the data receiver 101 performs the processing in this embodiment. In this embodiment, FIGS. 6 and 7 illustrate format examples of messages received by the data receiver 101. In case of the message received from the data source, as illustrated in FIG. 6, an ID (dⱼ) of data, an ID of a destination next node (i.e. a node of a direct transmission destination) of the data and a data body are included. The data body may include the ID of the data. Moreover, instead of the ID of the destination next node, a key to identify the destination next node may be included to identify the ID of the destination next node by using a data structure to identify, from the key, the ID of the destination next node.

In case of the message received from other nodes, as illustrated in FIG. 7, an ID of data, an ID of a destination next node of the data, a delivery time limit tₗᵢₘ up to the destination of the data dⱼ and a data body are included.

As illustrated in FIG. 8, the first latency data storage unit 105 stores, for each ID of the data, a latency that is allowed for the delivery from the data source to the destination.

Moreover, as illustrated in FIG. 9, the link data storage unit 103 stores, for each link ID, an ID of a transmission source (Source) node, an ID of a destination node (Destination), and a latency of the link.

Moreover, as illustrated in FIG. 10, the data transfer route storage unit 104 stores, for each ID of data, a link ID array ([L_{1,2}, L_{2,3}, . . . , L_{n-1,n}]) of a transfer route through which the data passes.

The first scheduler 102 uses the link data storage unit 103, the data transfer route storage unit 104 and the first latency data storage unit 105 to identify a delivery time limit (i.e. arrival time limit) up to the destination for the received message, identifies the transmission time limit at this node, and stores the identified transmission time limit and data of the message in the data queue 106.

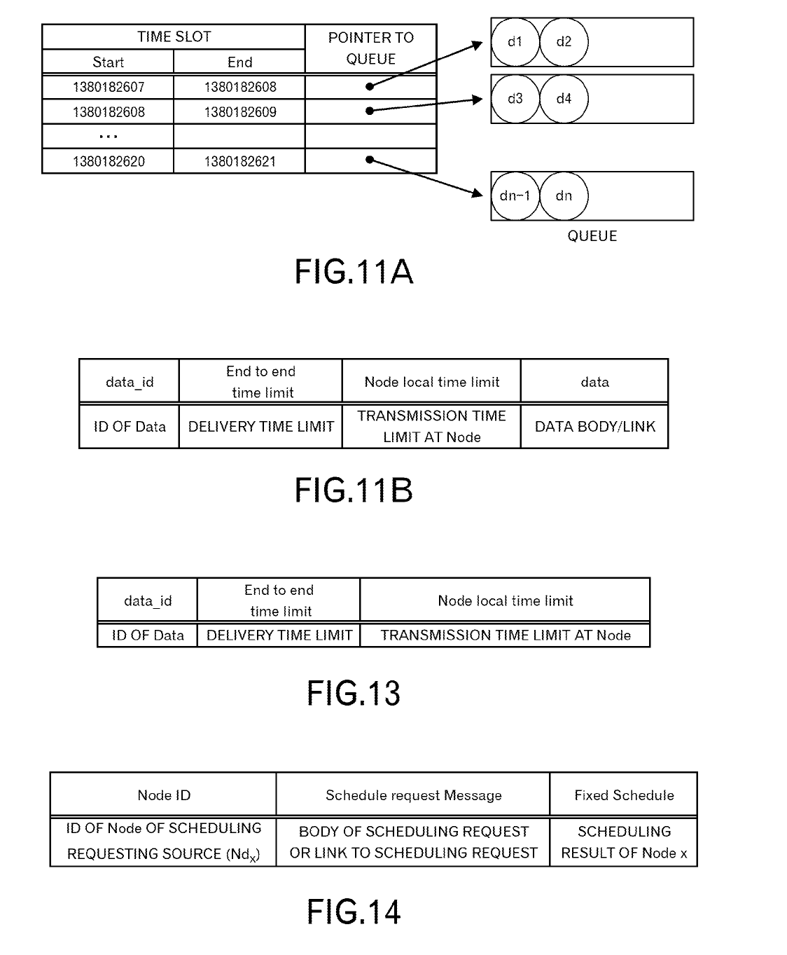

FIGS. 11A and 11B illustrates a data structure example of the data queue 106. In an example of FIG. 11A, for each time slot identified by a start time and an end time, a pointer (or link) to a queue for this time slot is registered. In the queue, a message (which corresponds to a data block) thrown into that queue is stored.

FIG. 11B illustrates a data format example of data thrown into the queue. In an example of FIG. 11B, an ID of data, a delivery time limit up to the destination, a transmission time limit at this node and a data body or a link to the data are included.

The data transmitter 107 transmits, for each time slot defined in the data queue 106, messages allocated to the time slot to the destination node or application.

The first schedule negotiator 108 generates a scheduling request including a transmission schedule from data stored in the data queue 106, and transmits the scheduling request to a node that is the transmission destination of the message. The first schedule negotiator 108 receives schedule notification including a scheduling result from the node that is the transmission destination of the message. Then, the first schedule negotiator 108 updates contents of the data queue 106 according to the received scheduling result.

The second scheduler 109 receives scheduling requests from other nodes, and stores the received scheduling requests in the scheduling data storage unit 111. Then, the second scheduler 109 changes a transmission schedule of each node by using data stored in the resource management data storage unit 110 and the scheduling requests from plural nodes, which are stored in the scheduling data storage unit 111.

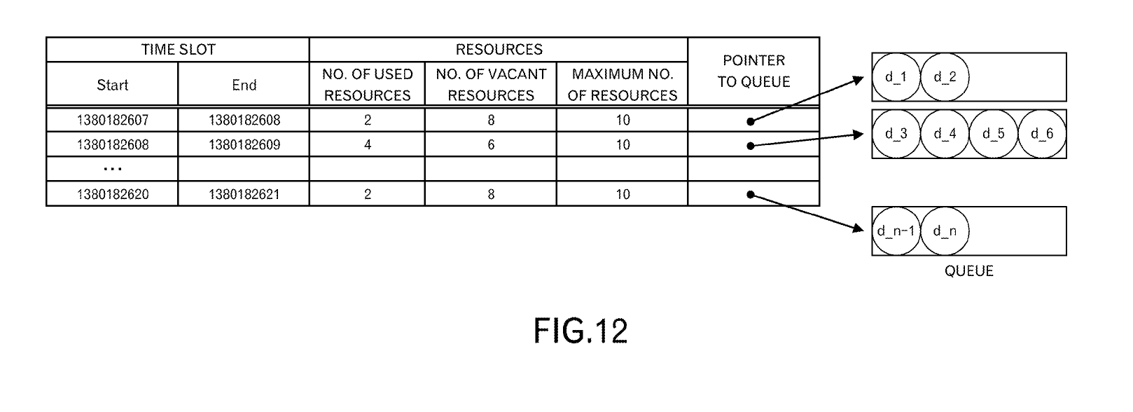

Data is stored in the resource management data storage unit 110 in data formats illustrated in FIGS. 12 and 13, for example. In other words, in an example of FIG. 12, for each time slot identified by the start time and the end time, the number of used resources, the number of vacant resources and the maximum number of resources for reception resources of the node and a pointer to a queue (also called “a data list”) for that time slot are stored. In this example, the width of the time slot is one second, and 10 data blocks (i.e. 10 messages) can be received per one time slot.

Information concerning data blocks thrown into a queue is stored in the queue. However, as illustrated in FIG. 13, this information includes, for each data block, an ID of data, a delivery time limit t_{lim,j} and a transmission time limit t_{lim,j,x} at a requesting source node x.

Moreover, data is stored in the scheduling data storage unit 111 in a data format as illustrated in FIG. 14, for example. In other words, for each ID of the node of the scheduling requesting source, a scheduling request itself or a link to the scheduling request and a scheduling result are stored. The second scheduler 109 transmits the scheduling result stored in the scheduling data storage unit 111 to each node.

The monitoring unit 115 detects congestion in a network based on a total size of messages for which data is stored in the data queue 106 and notifies to the second schedule negotiator 117.

Receiving notification that represents occurrence of congestion from the monitoring unit 115, the second schedule negotiator 117 generate a rescheduling request including a transmission schedule by using data stored in the data queue 106. Then, the second schedule negotiator 117 transmits the generated rescheduling request to a node of the message transmission destination. Then, the second schedule negotiator 117 receives schedule notification including a scheduling result from the node of the message transmission destination. Then, the second schedule negotiator 117 updates contents of the data queue 106 according to the received scheduling result.

The third scheduler 113 receives rescheduling requests from other nodes. Then, the third scheduler 113 changes a transmission schedule for a node of the transmission source of the rescheduling request by using the received rescheduling requests, scheduling requests stored in the scheduling data storage unit 111, and data stored in the resource management data storage unit 110. The third scheduler 113 transmits schedule notification including the rescheduling result to the node of the transmission source of the rescheduling request.

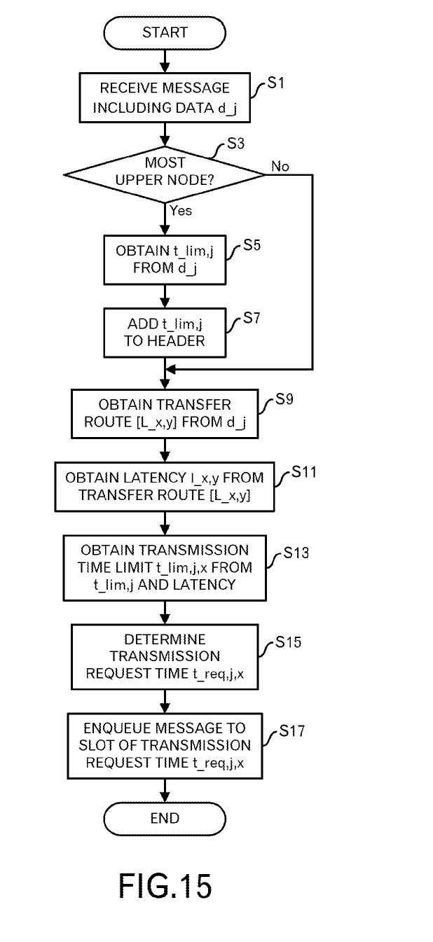

Next, processing details of the node will be explained by using FIGS. 15 to 28.

Firstly, processing details when the message is received will be explained by using FIG. 15. Underbars is used in figures to represent subscript letters.

The data receiver 101 receives a message including data (dⱼ) and outputs the message to the first scheduler 102 (step S1). When its own node is the most upper node connected to the data source (step S3: Yes route), the first scheduler 102 searches the first latency data storage unit 105 for the data ID “dⱼ” to read out a latency that is allowed up to the destination, and obtains the delivery time limit t_{lim,j} (step S5). For example, the delivery time limit is calculated by “present time+latency”. When the delivery time limit itself is stored in the first latency data storage unit 105, it is used. On the other hand, when its own node is not the most upper node (step S3: No route), the processing shifts to step S9.

Moreover, the first scheduler 102 adds the delivery time limit t_{lim,j} to the received message header (step S7). By this step, a message as illustrated in FIG. 7 is generated.

Furthermore, the first scheduler 102 searches the data transfer route storage unit 104 for dⱼ to read out a transfer route [L_{x,y}] (step S9). In this embodiment, the transfer route is array data of link IDs.

Then, the first scheduler 102 searches the first latency data storage unit 105 for each link ID in the transfer route [L_{x,y}], and reads out the latency l_{x,y} of each link (step S11).

After that, the first scheduler 102 calculates a transmission time limit t_{lim,j,x} at this node from the delivery time limit t_{lim,j} and the latency l_{x,y}(step S13). Specifically, “t_{lim,j}−Σl_{x,y} (a total sum with respect to all links on the transfer route)” is performed.

Then, the first scheduler 102 determines a transmission request time t_{req,j,x} from the transmission time limit t_{lim,j,x} (step S15). “t_{lim,j,x}=t_{req,j,x}” may hold, and “t_{req,j,x}=t_{lim,j,x}−α” may be employed considering a constant margin a. In the following explanation, “the transmission time limit=transmission request time” holds in order to make the explanation easy.

Then, the first scheduler 102 throws the message and additional data into the time slot of the transmission request time t_{req,j,x} (step S17). Data as illustrated in FIG. 11B is stored.

The aforementioned processing is performed every time when the message is received.

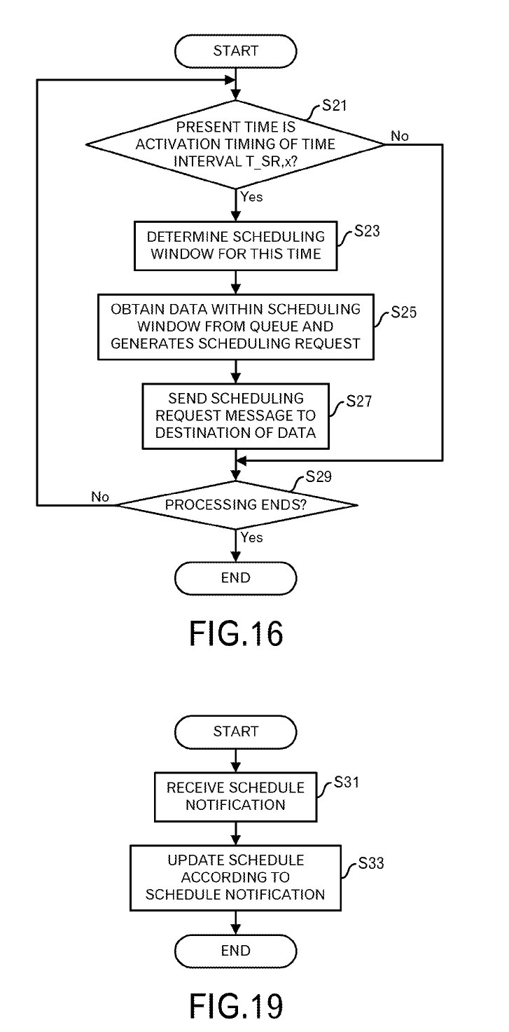

Next, processing details of the first schedule negotiator 108 will be explained by using FIGS. 16 to 20.

Firstly, the first schedule negotiator 108 determines whether or not the present time is an activation timing of a time interval T_{SR,x} (FIG. 16: step S21). The processing shifts to step S29 when the present time is not the activation timing. On the other hand, when the present time is the activation timing, the first schedule negotiator 108 determines a scheduling window for this time (step S23). Specifically, as explained in FIG. 3, when the present time is “t”, a time band from “t+Mₓ” to “t+Mₓ+wΔt” is the scheduling window for this time. In this embodiment, all nodes within the system are synchronized.

Then, the first schedule negotiator 108 reads out data (except data body itself) within the scheduling window from the data queue 106, and generates a scheduling request (step S25).

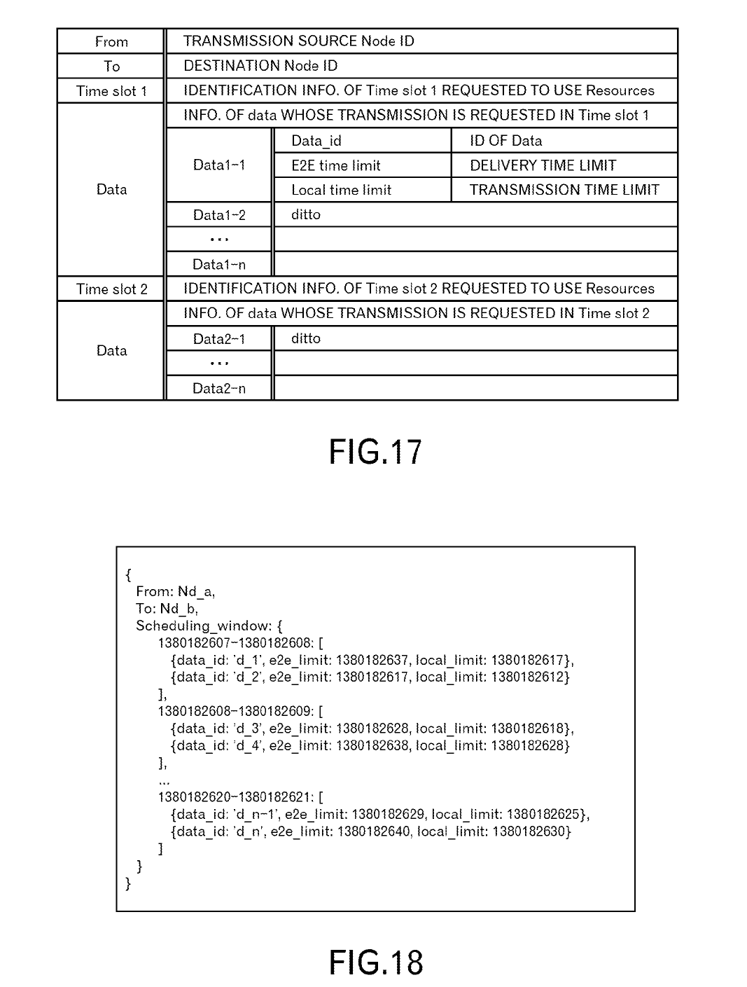

FIG. 17 illustrates a data format example of the scheduling request. In an example of FIG. 17, an ID of a transmission source node, an ID of a destination node and data for each time slot are included. Data for each time slot includes identification information of the time slot (e.g. start time-end time), and an ID of data, a delivery time limit and a transmission time limit for each data block (i.e. message).

For example, when specific values are inputted in the Javascript Object Notation (JSON) format, an example of FIG. 18 is obtained. In the example of FIG. 18, data concerning two data blocks for the first time slot is included, data concerning two data blocks for the second time slot is included, and data concerning two data blocks for the last time slot is included.

After that, the first schedule negotiator 108 transmits the scheduling request to a transmission destination of the data (step S27).

Then, the first schedule negotiator 108 determines whether or not the processing end is instructed (step S29), and when the processing does not end, the processing returns to the step S21. On the other hand, when the processing ends, the processing ends.

By transmitting the scheduling request for plural time slots as described above, adjustment of the transmission timing is properly performed.

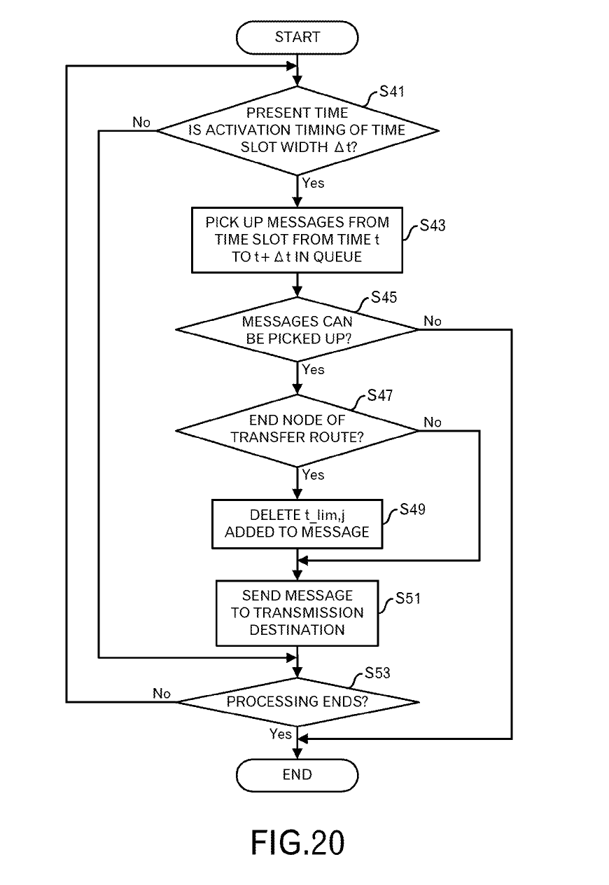

Next, processing when the schedule result is received will be explained by using FIGS. 19 and 20.

The first schedule negotiator 108 receives schedule notification including the schedule result (FIG. 19: step S31). A data format of the schedule notification is a format as illustrated in FIGS. 17 and 18.

Then, when the first schedule negotiator 108 received the schedule notification, the first schedule negotiator 108 performs processing to update the time slots into which the message in the data queue 106 (i.e. data block) is thrown according to the schedule notification (step S33). When the transmission schedule notified by the schedule notification is identical to the transmission schedule in the scheduling request, no special processing is performed. When a data block has been moved to a different time slot, the data block is enqueued in a queue for the changed time slot. When there is no data for that time slot, the time slot is generated at this stage.

Thus, a transmission schedule adjusted in the node of the transmission destination can be reflected to the data queue 106.

Next, processing details of the data transmitter 107 will be explained by using FIG. 20.

The data transmitter 107 determines whether or not the present time becomes an activation timing t, which occurs at intervals of a time slot width Δt (FIG. 20: step S41). When the present time is not the activation timing t, the processing shifts to step S53. On the other hand, when the present time becomes the activation timing t, the data transmitter 107 performs processing to read out messages (i.e. data blocks) from a queue for a time band from time “t” to “t+Δt” in the data queue 106 (step S43).

When it is not possible to read out data of the messages at the step S43 (step S45: No route), processing for this time slot ends.

On the other hand, when the data of the messages can be read out (step S45: Yes route), the data transmitter 107 determines whether or not its own node is an end node of the transfer route (step S47). In other words, it is determined whether or not its own node is a node that outputs the messages to an application.

Then, when its own node is the end node, the data transmitter 107 deletes the delivery time limit attached to the read message (step S49). On the other hand, when its own node is not the end node, the processing shifts to step S51.

After that, the data transmitter 107 transmits the read messages to the destinations (step S51). Then, the data transmitter 107 determines whether or not the processing ends (step S53), and when the processing does not end, the processing returns to the step S41. On the other hand, when the processing ends, the processing ends.

Thus, the message can be transmitted according to the transmission schedule determined by the node of the transmission destination. Therefore, data that can be received with the reception resource of the node of the transmission destination is transmitted. Therefore, the delay of the data transmission is suppressed.

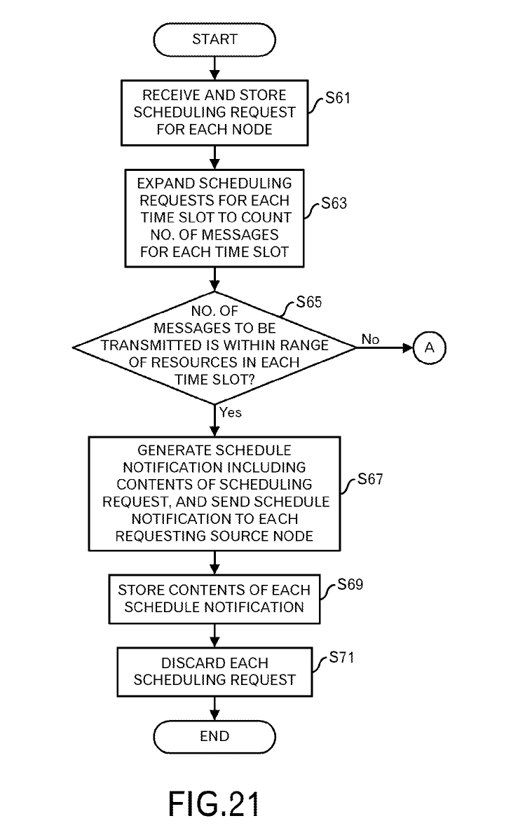

Next, processing details of the second scheduler 109 will be explained by using FIGS. 21 to 28.

The second scheduler 109 receives a scheduling request from each node near the data source, and stores the received scheduling request in the scheduling data storage unit 111 (FIG. 21: step S61).

Then, the second scheduler 109 expands the respective scheduling requests for the respective time slot to count the number of messages (i.e. the number of data blocks) for each time slot (step S63). This processing result is stored in the resource management data storage unit 110 as illustrated in FIGS. 12 and 13.

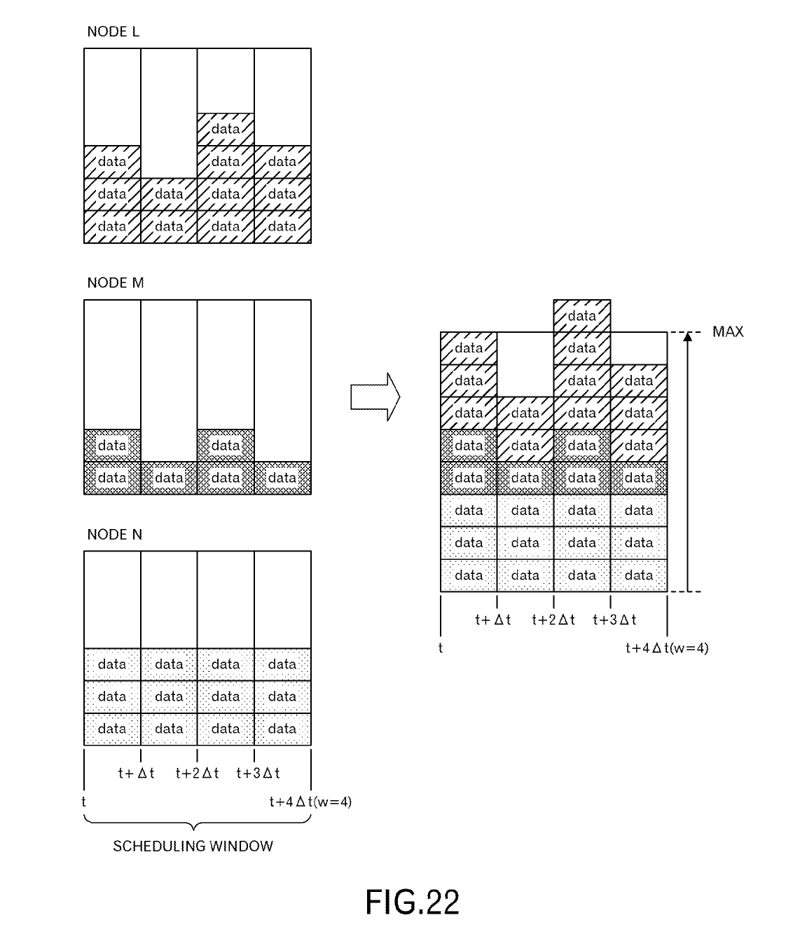

FIG. 22 illustrates a specific example of this step. In an example of FIG. 22, a case is depicted where the scheduling requests were received from the nodes L to N, and data of the transmission schedule for each of 4 time slots is included. When such transmission schedules are superimposed for each time slot, a state illustrated in the right side of FIG. 22 is obtained. Data representing such a state is stored in the data format as illustrated in FIGS. 12 and 13. In this example, 8 data blocks that are the upper limit of the reception resources are allocated to the first time slot, 6 data blocks that are less than the reception resources are allocated to the second time slot, 9 data blocks, which exceeds the reception resources, are allocated to the third time slot, and 7 data blocks that is less than the reception resources are allocated to the fourth time slot.

Then, the second scheduler 109 determines whether or not the number of messages (the number of data blocks) that will be transmitted in each time slot is within a range of the reception resources (i.e. less than the maximum value) (step S65). When the number of messages that will be transmitted in each time slot is within the range of the reception resource, the second scheduler 109 transmits schedule notification including contents of the scheduling request stored in the scheduling data storage unit 111 to each requesting source node (step S67). In such a case, this is because it is possible to receive the messages without changing the transmission schedule of each node.

Then, the second scheduler 109 stores the contents of the respective schedule notifications in the scheduling data storage unit 111 (step S69). Moreover, the second scheduler 109 discards the respective schedule requests that were received this time (step S71).

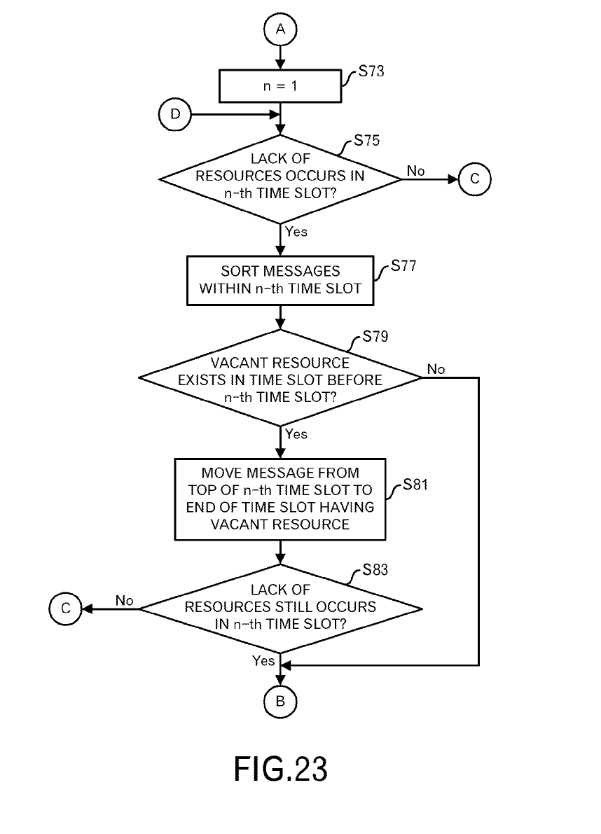

On the other hand, when the number of messages for any of the time slots exceeds the range of the reception resources, the processing shifts to processing in FIG. 23 through terminal A.

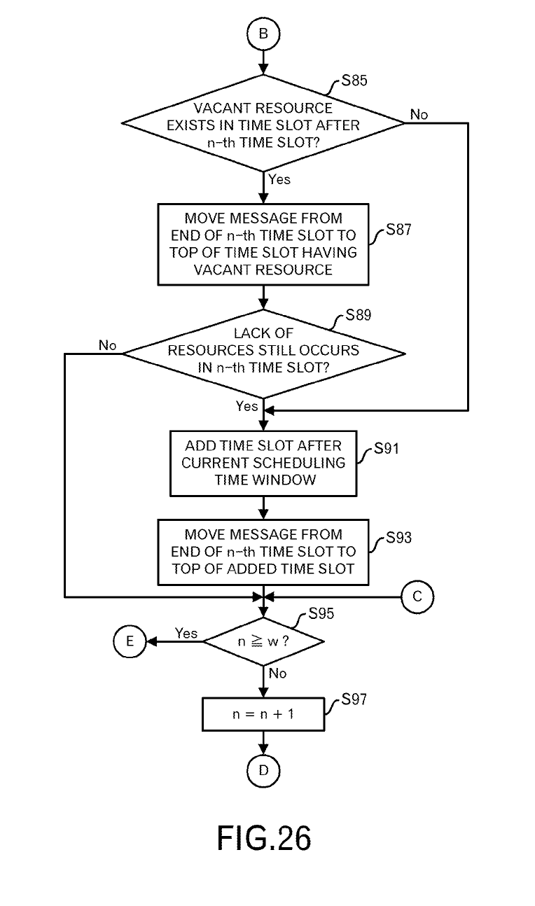

Firstly, the second scheduler 109 initializes a counter n for the time slot to “1” (step S73). Then, the second scheduler 109 determines whether or not the number of messages for the n-th time slot exceeds the reception resources (step S75). When the number of the messages for the n-th time slot is within the reception resources, the processing shifts to processing in FIG. 26 through terminal C.

On the other hand, when the number of messages for the n-th time slot exceeds the range of the reception resources, the second scheduler 109 sorts the messages within the n-th time slot by using, as a first key, the transmission time limit of the transmission source node and by using, as a second key, the delivery time limit (step S77).

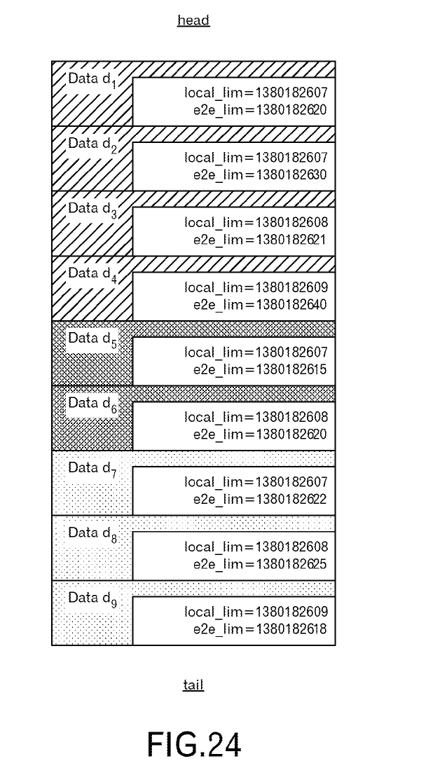

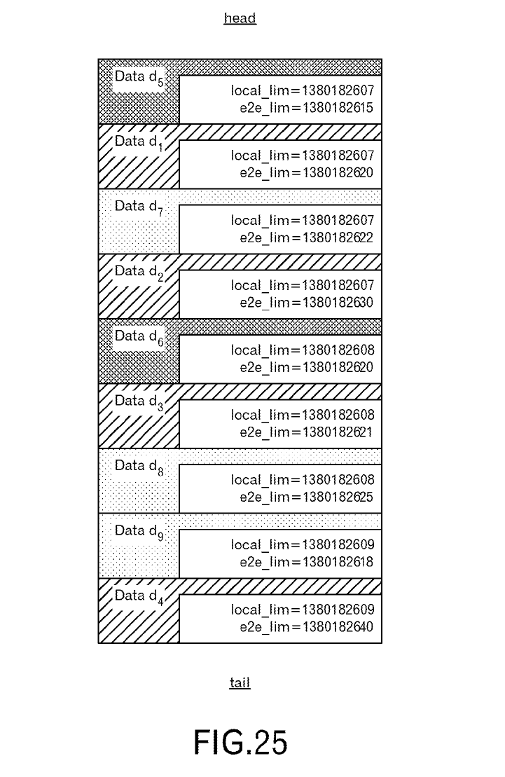

A specific example of this step will be explained for the third time slot in FIG. 22 by using FIGS. 24 and 25. In this example, the top of the queue (also called “a data list”) is the first and the bottom of the queue is the end. In FIG. 24, among 9 messages (i.e. data blocks), first to fourth messages are messages for the node L, fifth and sixth messages are messages for the node M, and seventh to ninth messages are messages for the node N. e2e_lim represents the delivery time limit, and local_lim represents the transmission time limit at the node. As described above, when these messages are sorted by using the transmission time limit and the delivery time limit, a result as illustrated in FIG. 25 is obtained. In other words, the messages allocated to the same time slot are prioritized by the transmission time limit and the delivery time limit.

After that, the second scheduler 109 determines whether or not there is a vacant reception resource for a time slot before the n-th time slot (step S79). When there is no vacant reception resource, the processing shifts to the processing in FIG. 26 through terminal B. When it is possible to schedule the transmission for an earlier time, the possibility of the data transmission delay can be suppressed. Therefore, firstly, the previous time slots are checked.

On the other hand, when there is a vacant reception resource in the time slot before the n-th time slot, the second scheduler 109 moves a message from the top in the n-th time slot to the end of the time slot having a vacant reception resource (step S81).

In an example illustrated in FIG. 22, because there is a vacant reception resource in the second time slot, which is a previous time slot of the third time slot, the top message in the third time slot is moved to the end of the second time slot.

There is a case where two or more messages exceed the range of the reception resources. In such a case, messages of the number of vacant reception resources in the time slots before the n-th time slot are picked up and moved from the top in the n-th time slot. When three messages exceed the range of the reception resources, however, there are only two vacant reception resources in the previous time slot, only two messages are moved to the previous time slot. A countermeasure for one remaining message is determined in the following processing.

Then, the second scheduler 109 determines whether or not the present state is a state that messages that exceed the range of the reception resources are still allocated to the n-th time slot (step S83). When this condition is satisfied, the processing shifts to the processing in FIG. 26 through the terminal B.

On the other hand, when the number of messages in the n-th time slot is within the range of the reception resources, the processing shifts to the processing in FIG. 26 through the terminal C.

Shifting to the explanation of the processing in FIG. 26, the second scheduler 109 determines whether or not there is a vacant reception resource in a time slot after the n-th time slot (step S85). When there is no vacant reception resource, the processing shifts to step S91.

On the other hand, when there is a vacant reception resource in the time slot after the n-th time slot, the second scheduler 109 moves the message from the end of the n-th time slot to the top of the time slot having the vacant reception resource (step S87).

In the example illustrated in FIG. 22, when it is assumed that there is no vacant reception resource in the time slot before the third time slot, there is a vacant time slot also in the fourth time slot. Therefore, the message in the end of the third time slot is moved to the top of the fourth time slot.

There is a case where two or more messages exceed the range of the reception resource. In such a case, messages of the number of vacant reception resources in the time slots after the n-th time slot are picked up and moved from the end of the n-th time slot. When three messages exceed the range of the reception resources, however, there are only two vacant reception resources in the rear time slot, only two messages are moved to the rear time slot. One remaining message will be processed later.

Furthermore, the second scheduler 109 determines whether or not the present state is a state where the messages that exceed the range of the reception resources are still allocated to the n-th time slot (step S89). When such a condition is not satisfied, the processing shifts to step S95.

When such a condition is satisfied, the second scheduler 109 adds a time slot after the current scheduling window (step S91). Then, the second scheduler 109 moves messages that exceed the range of the reception resources at this stage from the end of the n-th time slot to the top of the added time slot (step S93).

By doing so, in each time slot in the scheduling window, it is possible to suppress the receipt of the messages within the range of the reception resources. Therefore, the congestion is suppressed, and the delay of the data transmission is also suppressed.

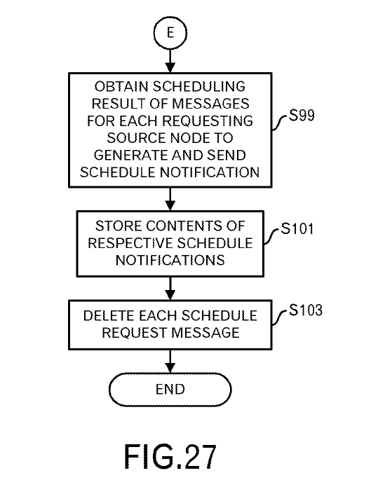

Then, the second scheduler 109 determines whether or not a value of the counter n is equal to or greater than the number of time slots w within the scheduling window (step S95). When this condition is not satisfied, the second scheduler 109 increments n by “1” (step S97), and the processing returns to the step S75 in FIG. 23 through terminal D. On the other hand, when n is equal to or greater than w, the processing shifts to processing in FIG. 27 through terminal E.

Shifting to the explanation of the processing in FIG. 27, the second scheduler 109 extracts, for each requesting source node, the scheduling result (i.e. transmission schedule) of those messages, generates schedule notification, and transmits the generated schedule notification to each requesting source node (step S99).

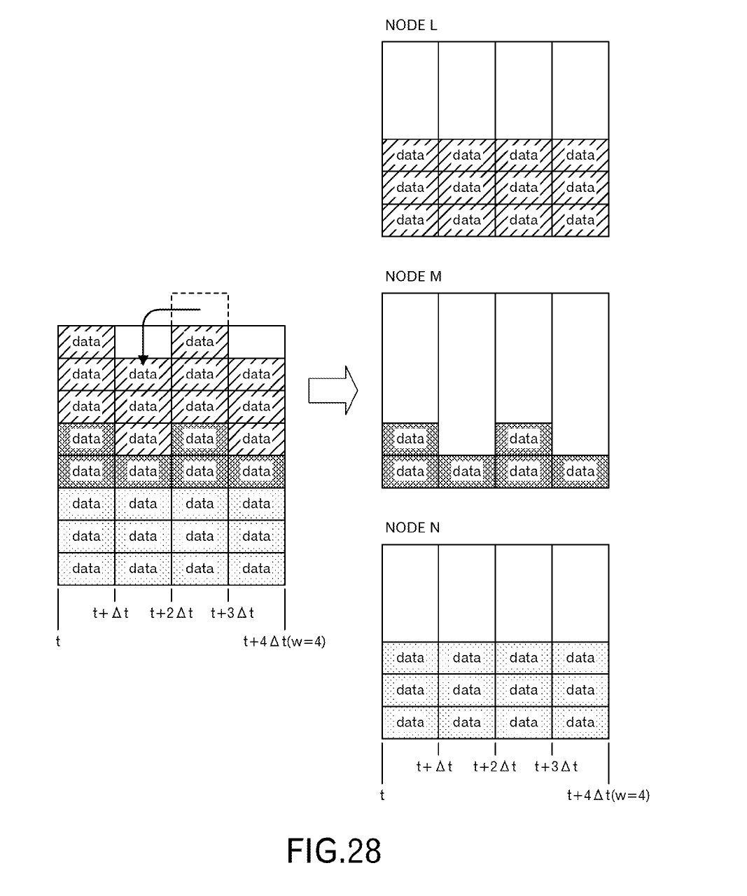

As illustrated in FIG. 28, because data blocks (messages) of the node L in the third time slot are moved to the second time slot, the transmission schedule that data blocks (messages) are transmitted uniformly from the first time slot to the fourth time slot is instructed in the schedule notification for the node L.

Then, the second scheduler 109 stores contents of the respective scheduling notification in the scheduling data storage unit 111 (step S101). Moreover, the second scheduler 109 discards the respective scheduling requests that were received this time (step S103).

By performing the processing as described above, it becomes possible to receive data from a transmission source node within a range of reception resources of data. Therefore, congestion is suppressed, and delay of data transmission is also suppressed.

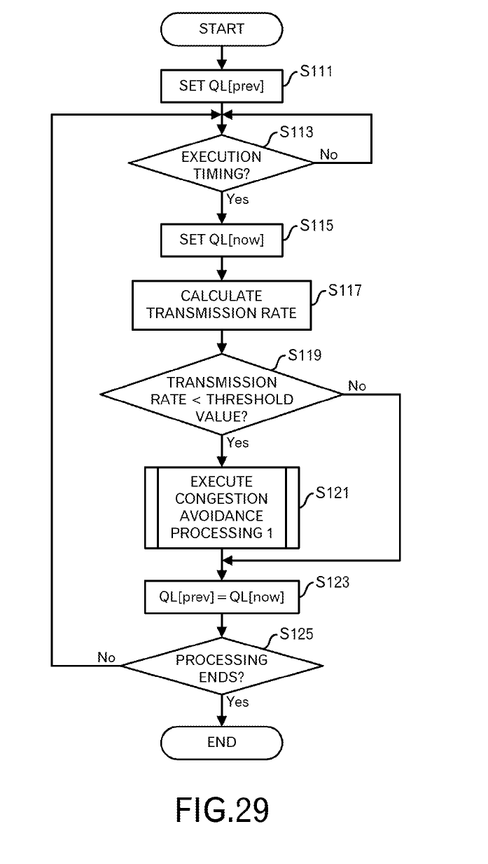

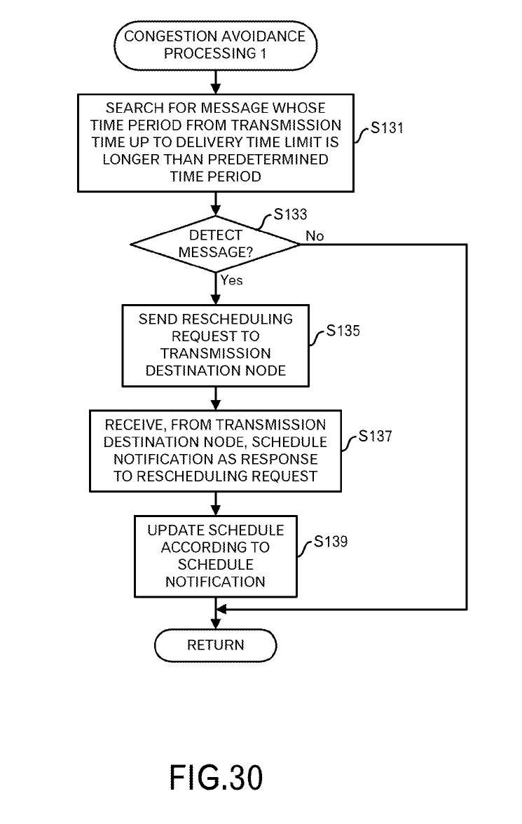

Next, processing executed by the monitoring unit 115 will be explained by using FIGS. 29 and 30.

Firstly, the monitoring unit 115 sets a variable QL[prev] representing a previous total size to a present total size of the messages for which data is stored in the data queue 106 (FIG. 29: step S111). At the step S111, when a size of each message is identical, it is possible to find the present total size by multiplying the size by the number of messages. When the size of each message is not identical, the present total size may be calculated at the step S111.

The monitoring unit 115 determines whether the present time is an execution timing (step S113). In this embodiment, because the monitoring unit 115 regularly executes processing, it is determined, at the step S113, whether a predetermined execution interval has passed since the previous execution.

When the present time is not the execution timing (step S113: No route), the processing stops for a certain amount of time, and returns to the step S113. On the other hand, when the present time is the execution timing (step S113: Yes route), the monitoring unit 115 sets a variable QL[now] representing a total size at this time to a present total size of messages for which data is stored in the data queue 106 (step S115).

The monitoring unit 115 calculates a transmission rate based on the QL[prev] and the QL[now] (step S117). For example, a decrease rate of a queue length ((QL[prev]−QL[now])/execution interval) is set as a transmission rate.

The monitoring unit 115 determines whether the transmission rate calculated at the step S117 is less than a threshold value (step S119). The threshold value in the step S119 is, for example, a value obtained by subtracting a certain value from the transmission rate in the case where there is no congestion.

When the transmission rate is equal to or more than the threshold value (step S119: No route), it is possible to assume that there is no congestion. Therefore, the processing shifts to the processing of the step S123. On the other hand, when the transmission rate is less than the threshold value (step S119: Yes route), the monitoring unit 115 instructs the second schedule negotiator 117 to execute processing. In response to this, the second schedule negotiator 117 executes the congestion avoidance processing in the first embodiment (step S121). The congestion avoidance processing in the first embodiment will be explained by using FIG. 30.

Firstly, the second schedule negotiator 117 searches messages that will be transmitted in the present time slot for a message whose time period from a transmission time up to a delivery time limit t_{lim,j} is longer than a predetermined time period (FIG. 30: step S131). The transmission time is an end time of the present time slot, for example.

The second schedule negotiator 117 determines whether a message has been detected at the step S131 (step S133). When a message has not been detected (step S133: No route), the processing returns to the calling-source processing.

On the other hand, when a message has been detected (step S133: Yes route), the second schedule negotiator 117 reads out data (except data body itself) of the detected message, and generates a rescheduling request. A data format of the rescheduling request is the same as the data format of the scheduling request, which is illustrated in FIG. 17. Then, the second schedule negotiator 117 sends the rescheduling request to a transmission destination node of the detected message (step S135). Processing executed by a node that received the rescheduling request will be explained later.

The second schedule negotiator 117 receives schedule notification including a schedule result from the transmission destination node (step S137) A data format of the schedule notification received as a response to the rescheduling request is the format as illustrated in FIGS. 17 and 18.

Then, when the second schedule negotiator 117 receives the schedule notification, the second schedule negotiator 117 updates, according to the schedule notification, transmission schedule data of the detected message, which is registered in the data queue 106 (step S139). Then, the processing returns to the calling-source processing. When the transmission schedule notified by the schedule notification is identical to the transmission schedule in the scheduling request, no special processing is performed. When a data block has been moved to a different time slot, the data block is enqueued in a queue for the changed time slot. When there is no data for that time slot, the time slot is generated at this stage.

Returning to the explanation of FIG. 29, the monitoring unit 115 sets QL[prev] to QL[now] (step S123).

The monitoring unit 115 determines whether the end of the processing has been instructed (step S125). When the end of the processing has not been instructed (step S125: No route), the processing returns to the step S113. On the other hand, when the end of the processing has been instructed (step S125: Yes route), the processing ends.

By executing the processing as described above, also when congestion occurred, it becomes possible to reset a schedule so as to avoid congestion.

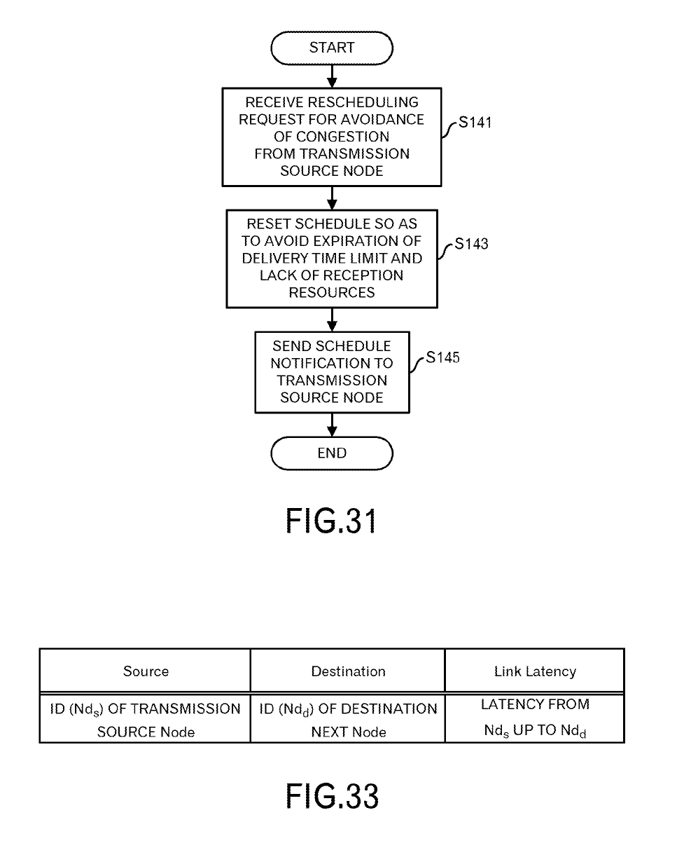

Next, processing executed by the third scheduler 113 will be explained by using FIG. 31. Firstly, the third scheduler 113 receives the rescheduling request for avoidance of congestion from a node of the transmission source of the message (FIG. 31: step S141), and stores the rescheduling request in the scheduling data storage unit 111.

The third scheduler 113 resets a schedule for the message designated in the rescheduling request so as to avoid expiration of a delivery time limit and lack of reception resources (step S143). For example, as illustrated in FIG. 4G, the schedule is changed so as to transmit, in the time slot after the present time slot, data blocks (namely, massages) that will be transmitted in the present time slot. However, delivery of the data blocks by the delivery time limit is ensured. Moreover, processing to check that the reception resources do not lack owing to changing the schedule is executed. Because this processing is the same as the processing executed by the second scheduler 109, the specific explanation of this processing is omitted here. At the step S143, a schedule included in the rescheduling request may be adopted as it is.

The third scheduler 113 generates schedule notification including a result of the rescheduling (namely, a transmission schedule), and transmits the schedule notification to the transmission source node (step S145). Then, the processing ends. The third scheduler 113 stores the contents of the schedule notification in the scheduling data storage unit 111. Moreover, the third scheduler 113 discards the rescheduling request that was received this time.

By executing the processing as described above, a transmission source node can transmit data so as to avoid congestion and expiration of a delivery time limit.

### Embodiment 2

In the second embodiment, a method for detecting congestion, which is different from the method in the first embodiment, is explained.

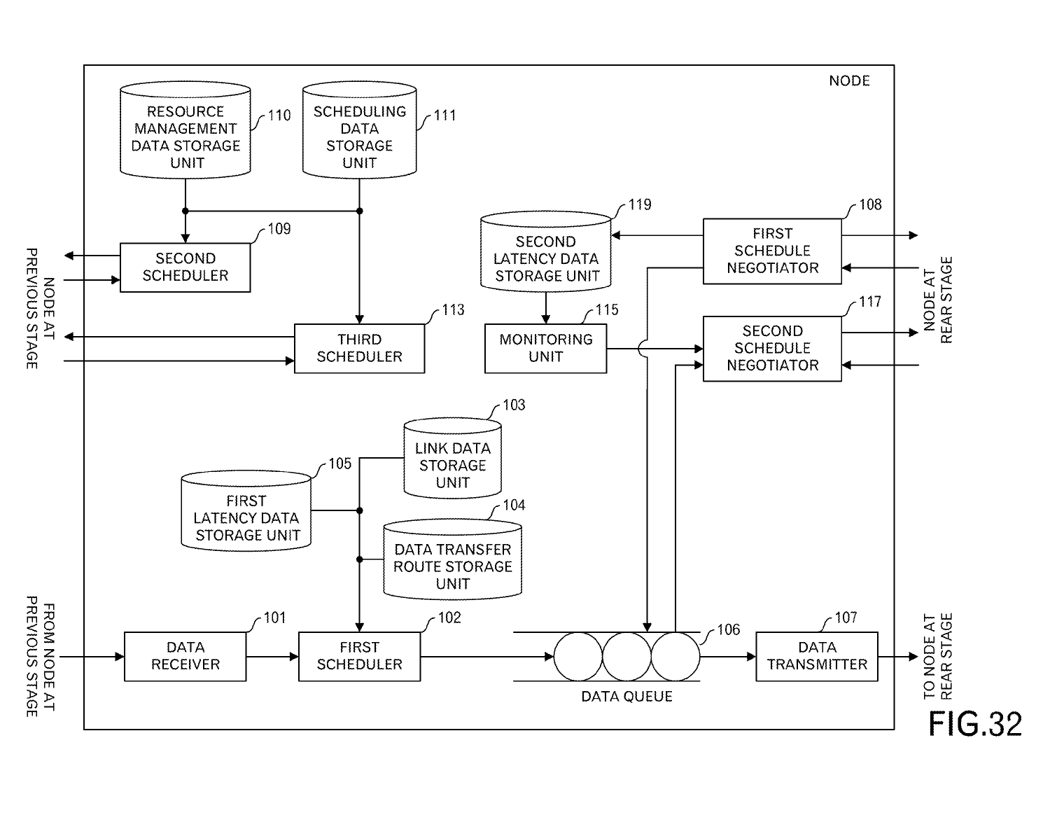

FIG. 32 illustrates a configuration example of each of the nodes A to C in the second embodiment. The node includes the data receiver 101, the first scheduler 102, the link data storage unit 103, the data transfer route storage unit 104, the first latency data storage unit 105, the data queue 106, the data transmitter 107, the first schedule negotiator 108, the second scheduler 109, the resource management data storage unit 110, the scheduling data storage unit 111, the third scheduler 113, the monitoring unit 115, the second schedule negotiator 117, and a second latency data storage unit 119.

FIG. 33 illustrates an example of data stored in the second latency data storage unit 119. In the example of FIG. 33, an ID of a transmission source node, an ID of a destination next node, a latency of a control message (here, time period needed to transfer from the transmission source node to the destination next node) are stored. The control message is schedule notification or the like, for example. The first schedule negotiator 108 calculates a latency of the received control message, and stores the latency in the second latency data storage unit 119. The latency of the control message is calculated based on a transmission time of the destination next node, which is included in the control message received from the destination next node, and reception time of the control message.

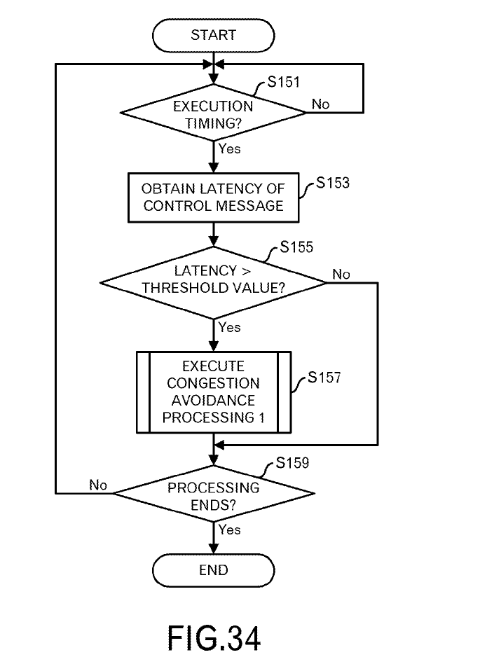

Next, processing executed by the monitoring unit 115 in the second embodiment will be explained by using FIG. 34.

The monitoring unit 115 determines whether the present time is an execution timing (FIG. 34: step S151). In this embodiment, because the monitoring unit 115 regularly executes processing, it is determined, at the step S151, whether a predetermined execution interval has passed since the previous execution.

When the present time is not the execution timing (step S151: No route), the processing stops for a certain period of time, and returns to the processing at the step S151. On the other hand, when the present time is the execution timing (step S151: Yes route), the monitoring unit 115 obtains a latency of a control message from the second latency data storage unit 119 (step S153).

The monitoring unit 115 determines whether the latency obtained at the step S153 exceeds a predetermined threshold value (step S155). The threshold value of the step S155 is obtained by subtracting a certain value from a latency in the case where there is no congestion, for example.

When the latency does not exceed the threshold value (step S155: No route), it is possible to assume that congestion is not occurring. Therefore, the processing shifts to the processing of the step S159. On the other hand, when the latency exceeds the threshold value (step S155: Yes route), the monitoring unit 115 instructs the second schedule negotiator 117 to execute the processing. In response to this, the second schedule negotiator 117 executes a congestion avoidance processing (step S157). Because the congestion avoidance processing executed at the step S157 is the same as the congestion avoidance processing executed at the step S121, the explanation of the congestion avoidance processing executed at the step S157 is omitted.

The monitoring unit 115 determines whether the end of the processing is instructed (step S159). When the end of the processing is not instructed (step S159: No route), the processing returns to the step S151. On the other hand, when the end of the processing is instructed (step S159: Yes route), the processing ends.

By doing the processing as described above, also when congestion has occurred, it becomes possible to reset a schedule so as to avoid the congestion.

### Embodiment 3

In the first and second embodiments, a pair of data transfer (here, a transmission source node and a destination next node) determines whether they perform scheduling for avoidance of congestion, and states of other pairs are not considered. Therefore, sometimes plural pairs perform scheduling for avoidance of congestion at the same timing in the same network. In the case, expiration of a delivery time limit is avoided, but a bandwidth of a network is more vacant than necessary, and utilization efficiency of the resources declines.

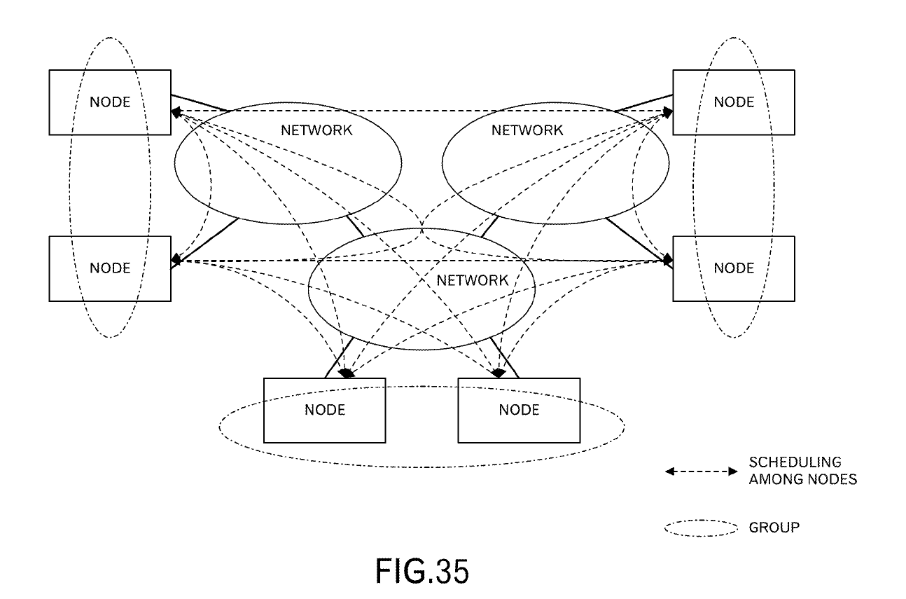

Therefore, in the third embodiment, transmission is controlled by using a degree of priority. Specifically, for example, as illustrated in FIG. 35, plural nodes that belong to the same group perform scheduling for avoidance of congestion cooperatively. In FIG. 35, nodes that belong to the same group are surrounded by a chain line, and 6 nodes belong to the same group. Each node exchanges information on degrees of priority with the other nodes that belong to the same group, and performs scheduling for the avoidance of congestion based on the degrees of priority.

Thus, by limiting nodes that operate cooperatively to nodes that belong to the same group, it becomes possible to reduce an amount of control messages transferred for schedule adjustment in comparison with a method for adjusting a schedule by setting up an apparatus that monitors the whole network.

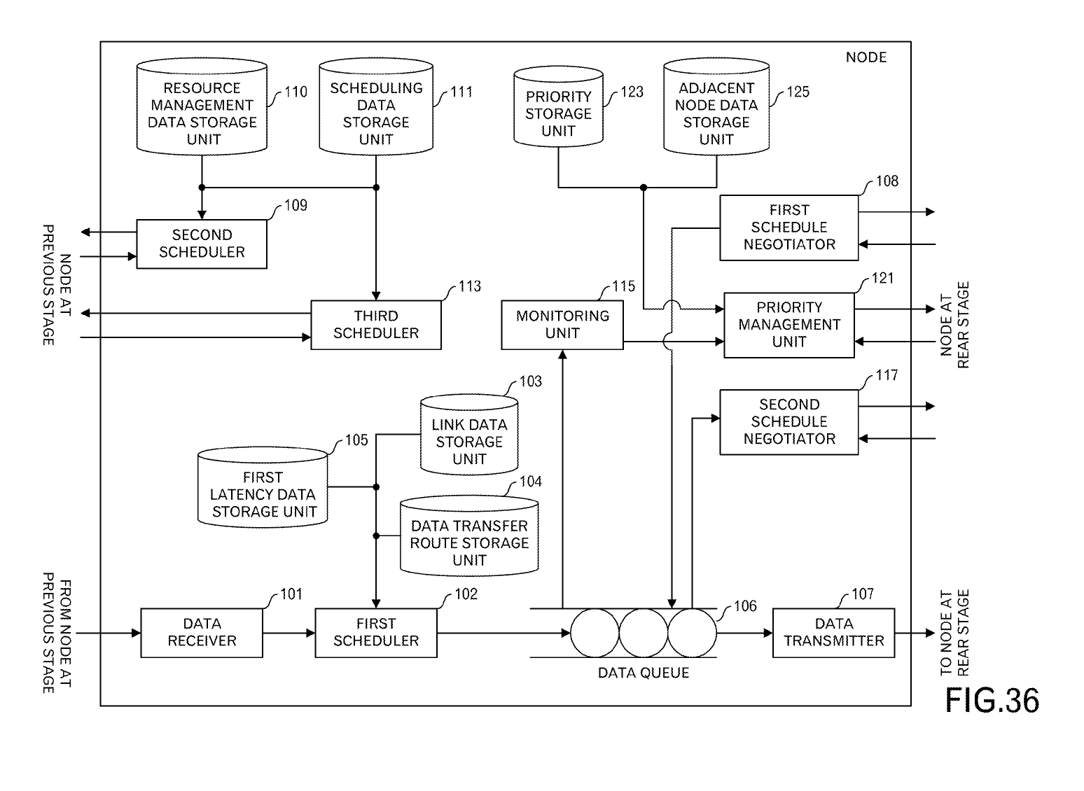

In the following, the third embodiment will be explained in detail. FIG. 36 illustrates a configuration example of each of the nodes A to C in the third embodiment. The node includes the data receiver 101, the first scheduler 102, the link data storage unit 103, the data transfer route storage unit 104, the first latency data storage unit 105, the data queue 106, the data transmitter 107, the first schedule negotiator 108, the second scheduler 109, the resource management data storage unit 110, the scheduling data storage unit 111, the third scheduler 113, the monitoring unit 115, the second schedule negotiator 117, a priority management unit 121, a priority storage unit 123, and an adjacent node data storage unit 125.

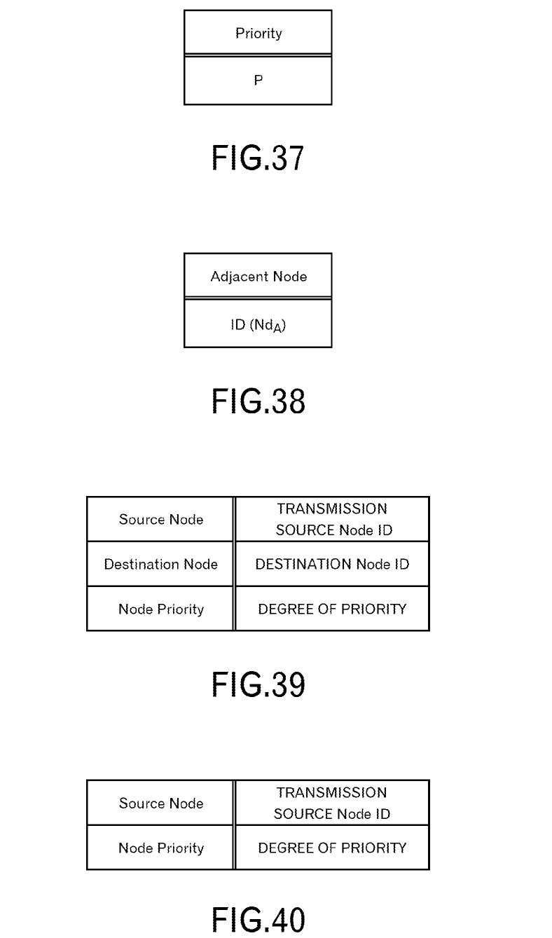

FIG. 37 illustrates an example of data stored in the priority storage unit 123. In the example of FIG. 37, information on a degree of priority that has been allocated to a node including the priority storage unit 123 is stored. A transmission destination of information on the degree of priority (hereinafter, referred to as an adjacent node) is identified based on data stored in the adjacent node data storage unit 125. FIG. 38 illustrates an example of data stored in the adjacent node data storage unit 125. In the example of FIG. 38, an ID of an adjacent node is stored.

FIG. 39 illustrates an example of a format of a message for exchanging information on a degree of priority. In the example of FIG. 39, an ID of a transmission source node of a message, an ID of a destination node (here, an adjacent node) of the message, and information on a degree of priority are included.

FIG. 40 illustrates an example of a message for notifying detection of congestion. In the example of FIG. 40, an ID of a transmission source node (here, a node that has detected congestion) and information on a degree of priority allocated to the node are included.

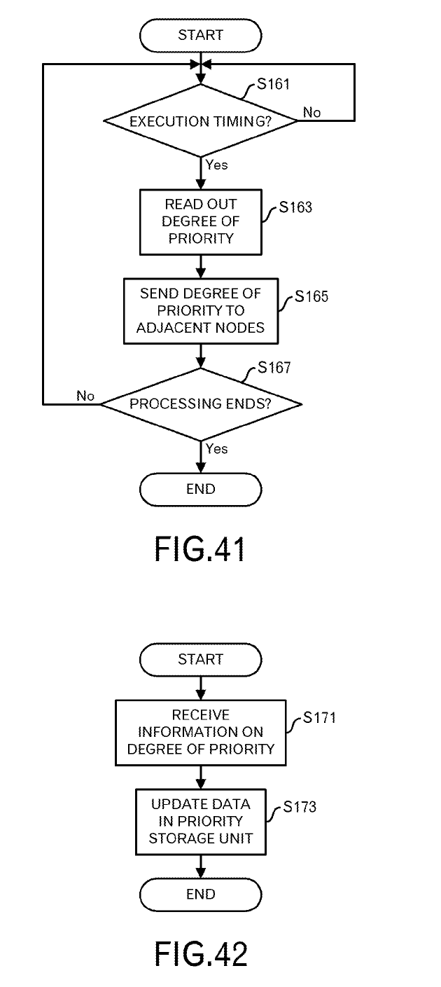

Next, processing executed by the priority management unit 121 will be explained by using FIGS. 41 to 43B. The priority management unit 121 determines whether the present time is an execution timing (FIG. 41: step S161). In this embodiment, because the priority management unit 121 regularly executes processing, it is determined, at the step S161, whether a predetermined execution interval has passed since the previous execution.

When the present time is not the execution timing (step S161: No route), the processing stops for a certain period of time, and returns to the processing at the step S161. On the other hand, when the present time is the execution timing (step S161: Yes route), the priority management unit 121 reads out, from the priority storage unit 123, information on a degree of priority allocated to a node that executes this processing (step S163).

The priority management unit 121 identifies an ID of an adjacent node from the adjacent node data storage unit 125. Then, the priority management unit 121 sends the information on the degree of priority read out at the step S163 to the adjacent node (step S165).

The priority management unit 121 determines whether the end of the processing has been instructed (step S167). When the end of the processing has not been instructed (step S167: No route), the processing returns to the step S161. On the other hand, when the end of the processing has been instructed (step S167: Yes route), the processing ends.

Then, as for reception of information on degrees of priority, the priority management unit 121 executes processing as described in the following. Firstly, the priority management unit 121 receives information on a degree of priority from other nodes (FIG. 42: step S171). Adjacent nodes for other nodes are nodes that execute this processing.

The priority management unit 121 updates data stored in the priority storage unit 123 by the received information on the degree of priority (step S173). Information on the degree of priority, which is stored in the priority storage unit 123, is regularly updated by the processing of the step S173.

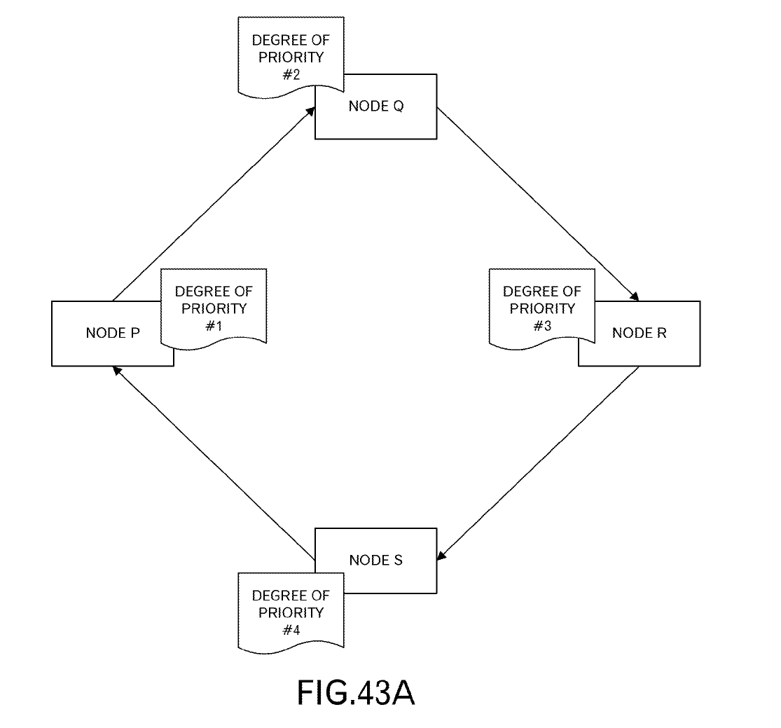

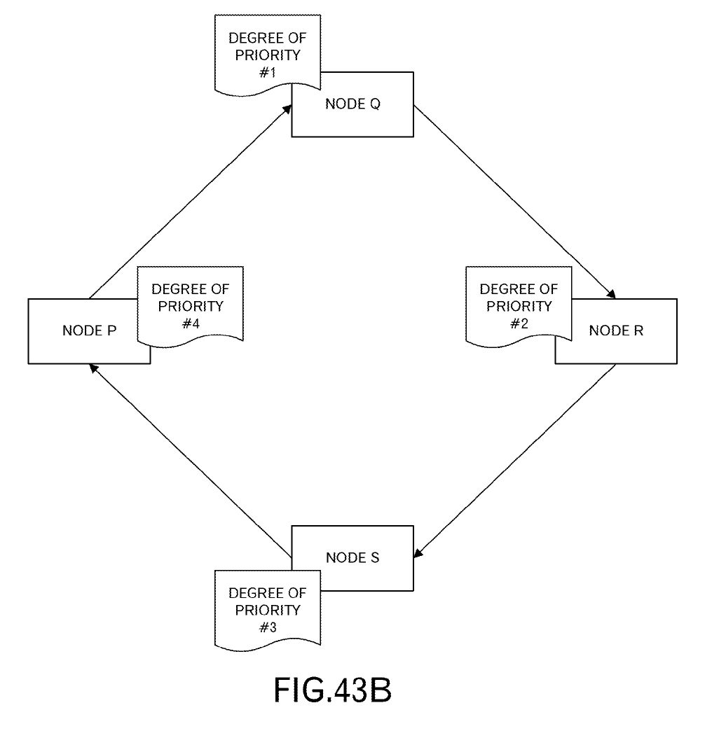

If each node executes the processing as described above, plural nodes that belong to the same group can exchange their degrees of priority. For example, assume that degrees of priority are allocated as illustrated in FIG. 43A. In the example of FIG. 43A, degree of priority #1 is allocated to a node P, degree of priority #2 is allocated to a node Q, degree of priority #3 is allocated to a node R, and degree of priority #4 is allocated to a node S. Here, an adjacent node for the node P is the node Q, an adjacent node for the node Q is the node R, an adjacent node for the node R is the node S, an adjacent node for the node S is the node P.

When degrees of priority are exchanged in such a state, a state as illustrated in FIG. 43B is obtained. In FIG. 43B, the degree of priority #4 is allocated to the node P, the degree of priority #1 is allocated to the node Q, the degree of priority #2 is allocated to the node R, and the degree of priority #3 is allocated to the node S.

By exchanging degrees of priority as described above, it becomes possible to prevent a degree of priority allocated to a specified node from being always in a high state.

Next, a congestion avoidance processing in the third embodiment will be explained. The congestion avoidance processing in the third embodiment is executed, similarly to the first and second embodiments, when the monitoring unit 115 instructs the second schedule negotiator 117 to execute processing.

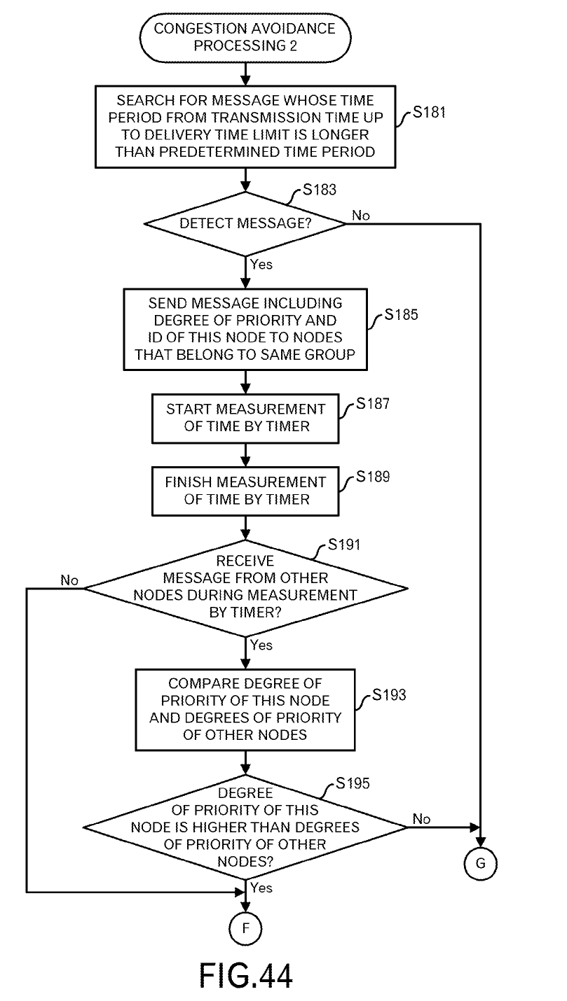

Firstly, the second schedule negotiator 117 searches messages that will be transmitted in the present time slot for a message whose time period from a transmission time to a delivery time limit t_{lim,j} is longer than a predetermined time period (FIG. 44: step S181). The transmission time is an end time of the present time slot, for example.

The second schedule negotiator 117 determines whether a message has been detected at the step S181 (step S183). When the message has not been detected (step S183: No route), the processing returns to the calling-source processing.

On the other hand, when the message has been detected (step S183: Yes route), the second schedule negotiator 117 reads out information on a degree of priority from the priority storage unit 123. Then, the second schedule negotiator 117 transmits a message including the information on the degree of priority, which was read out, and an ID of this node to nodes that belong to the same group (step S185). A format of a message that is transmitted at the step S185 is a format illustrated in FIG. 40. Information on nodes that belong to the same group (for example, an address) is obtained in advance.

The second schedule negotiator 117 starts measurement of time by a timer (step S87), and finishes the measurement of time by the timer when a predetermined time period has passed (step S189).

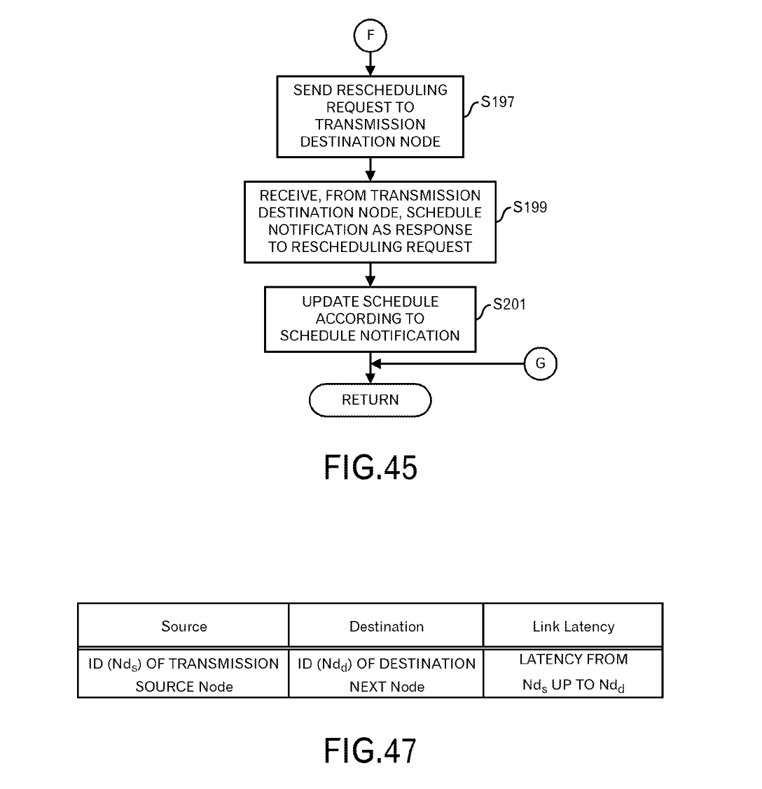

The second schedule negotiator 117 determines whether messages for notifying detection of congestion have been received from other nodes during the measurement of time by the timer (step S191). When the messages for notifying the detection of congestion have not been received from other nodes (step S191: No route), the congestion detected by this node can be avoided. Therefore, the processing shifts to the step S197 in FIG. 45 through a terminal F.

On the other hand, when the messages for notifying the detection of congestion have been received from other nodes (step S191: Yes route), the second schedule negotiator 117 compares a degree of priority of a transmission source node of the message, which is identified by information included in the received message, and a degree of priority of this node (step S193). When plural messages were received during the measurement of time by the timer, the degree of priority of a transmission source node of each of the plural messages and the degree of priority of this node are compared in the step S193.

The second schedule negotiator 117 determines whether the degree of priority of this node is higher than the degree of priority of other node (step S195). When plural messages are received during the measurement of time by the timer, it is determined whether the degree of priority of this node is higher than any of the degrees of priority of other nodes.

When the degree of priority of this node is not higher than the degrees of priority of other nodes (step S195: No route), avoidance of congestion detected by other nodes is to be prioritized. Therefore, the processing shifts to the processing of FIG. 45 through a terminal G, and returns to the calling-source processing. When the degree of priority of this node is higher than the degrees of priority of other nodes (step S195: Yes route), it is possible to execute avoidance of congestion detected by this node. Therefore, the processing shifts to the step S197 of FIG. 45 through a terminal F.

Shifting to the explanation of FIG. 45, the second schedule negotiator 117 reads out data of the message that was detected at the step S181 (except data body itself), and generates a rescheduling request. A data format of the rescheduling request is the same as the data format the scheduling request, which is illustrated in FIG. 17. Then, the second schedule negotiator 117 sends the rescheduling request to the transmission destination node of the detected message (step S197). The processing executed by the node that received the rescheduling request will be explained later.

The second schedule negotiator 117 receives schedule notification including a schedule result from a transmission destination node (step S199). A data format of the schedule notification received as a response to the rescheduling request is the format as illustrated in FIGS. 17 and 18.

Then, when the second schedule negotiator 117 receives the schedule notification, the second schedule negotiator 117 updates, according to the schedule notification, transmission schedule data of the detected message, which is registered in the data queue 106 (step S201). Then, the processing returns to the calling-source processing. When the transmission schedule notified by the schedule notification is identical to the transmission schedule in the scheduling request, no special processing is performed. When a data block has been moved to a different time slot, the data block is enqueued in a queue for the changed time slot. When there is no data for that time slot, the time slot is generated at this stage.

By executing the processing as described above, it is possible to prevent executing scheduling for avoidance of congestion regardless of occurrence of a vacant bandwidth in a network. Therefore, it is possible to suppress deterioration of utilization efficiency of the bandwidth in the network.

### Embodiment 4

In the fourth embodiment, a method for detecting congestion in a transmission destination of data and making a schedule to avoid detection of the congestion will be explained.

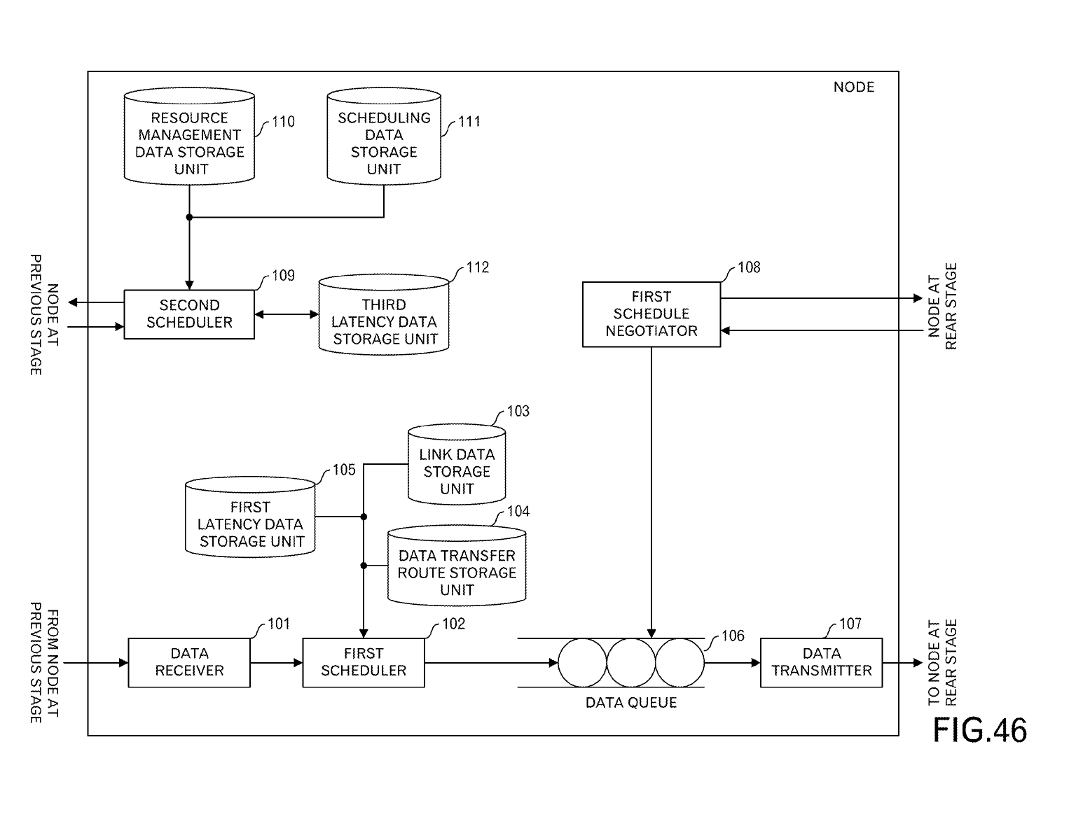

FIG. 46 illustrates a configuration example of each of the nodes A to C to perform the processing as described above. The node includes the data receiver 101, the first scheduler 102, the link data storage unit 103, the data transfer route storage unit 104, the first latency data storage unit 105, the data queue 106, the data transmitter 107, the first schedule negotiator 108, the second scheduler 109, the resource management data storage unit 110, the scheduling data storage unit 111, and a third latency data storage unit 112.

FIG. 47 illustrates an example of data stored in the third latency data storage unit 112. In the example of FIG. 47, an ID of a transmission source node, an ID of a destination next node, a latency of a control message (time period needed to transmit the control message from the transmission source node to the destination next node) are stored. The control message is a schedule request or the like, for example. The second scheduler 109 calculates the latency of the received control message, and stores the latency in the third latency data storage unit 112. The latency of a control message is calculated based on a transmission time of a destination next node, which is included in a control message received from the destination next node, and reception time of the control message.

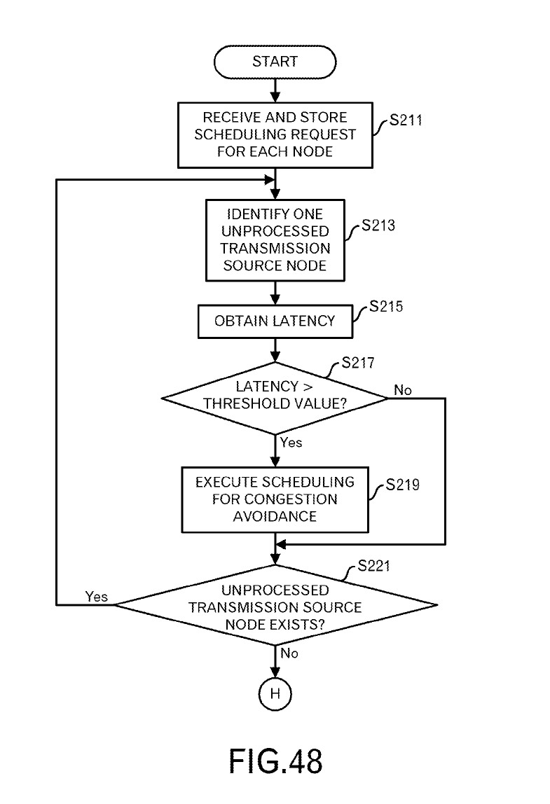

Next, the processing executed by the second scheduler 109 in the fourth embodiment is explained by using FIGS. 48 to 50B.

Firstly, the second scheduler 109 receives a scheduling request from each node near the data source, and stores the received scheduling request in the scheduling data storage unit 111 (FIG. 48: step S211).

The second scheduler 109 identifies one unprocessed transmission source node among transmission source nodes of scheduling requests (step S213), and obtains a latency of a control message from the third latency data storage unit 112 (step S215).

The second scheduler 109 determines whether the latency obtained at the step S215 exceeds a predetermined threshold value (step S217). The threshold value of the step S217 is a value obtained by subtracting a certain value from a latency in the case where there is no congestion, for example.

When the latency does not exceed the predetermined threshold value (step S217: No route), it is possible to assume that congestion is not occurring. Therefore, the processing shifts to the step S221. On the hand, when the latency exceeds the predetermined threshold value (step S217: Yes route), second scheduler 109 executes scheduling for avoidance of congestion (step S219). For example, as illustrated in FIG. 4G, the schedule is changed so as to transmit, in the time slot after the present time slot, data blocks (namely, messages) that is to be transmitted in the present time slot. However, delivery of the data blocks by the delivery time limit is ensured. Then, the scheduling request for the identified transmission source node is changed based on the scheduling result of the step S219, and is stored in the scheduling data storage unit 111.

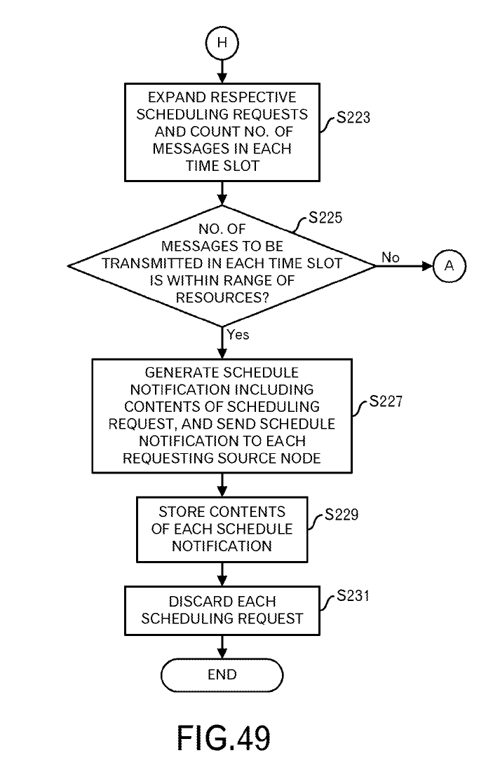

The second scheduler 109 determines whether an unprocessed transmission source node exists (step S221). When the unprocessed transmission source node exists (step S221: Yes route), the processing returns to the processing of the step S213 to process for the next transmission source node. On the other hand, when the unprocessed transmission source node does not exist (step S221: No route), the processing shifts to the step S223 of FIG. 49 through a terminal H.

Shifting to the explanation of FIG. 49, the second scheduler 109 expands respective scheduling requests for the respective time slot and counts the number of messages (the number of data blocks) in each time slot (step S223). As illustrated in FIGS. 12 and 13, this processing result is stored in the resource management data storage unit 110.

The second scheduler 109 determines whether the number of messages (the number of data blocks) to be transmitted in each time slot is within a range of the reception resources (namely, equal to or less than the maximum value) (step S225).

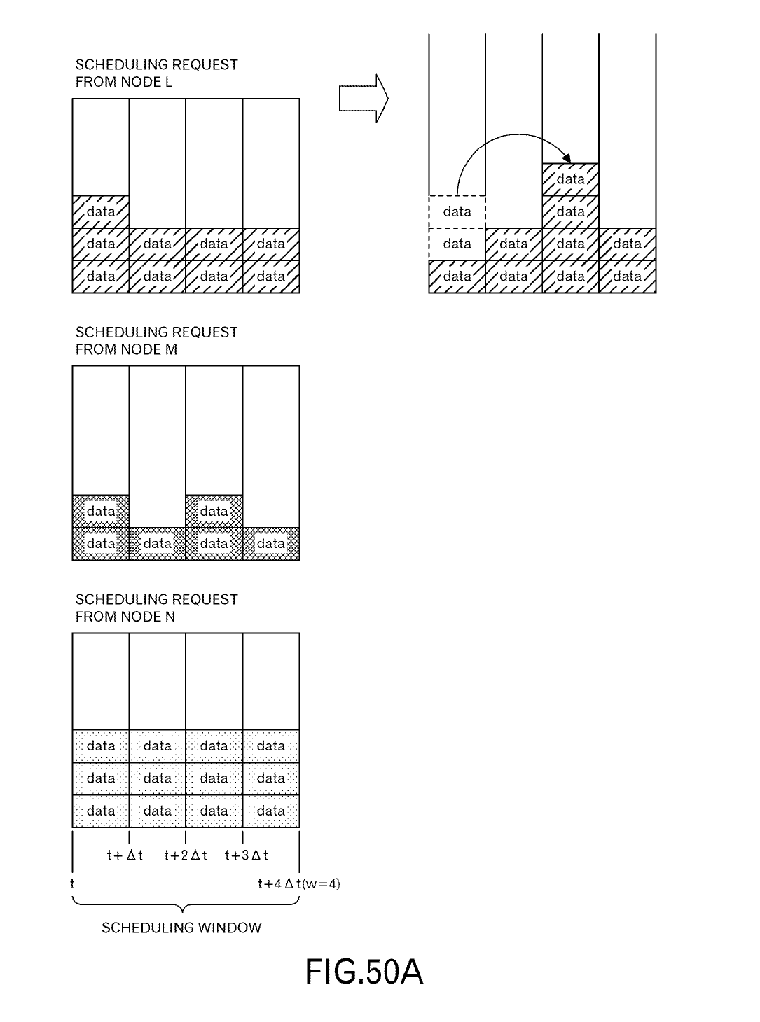

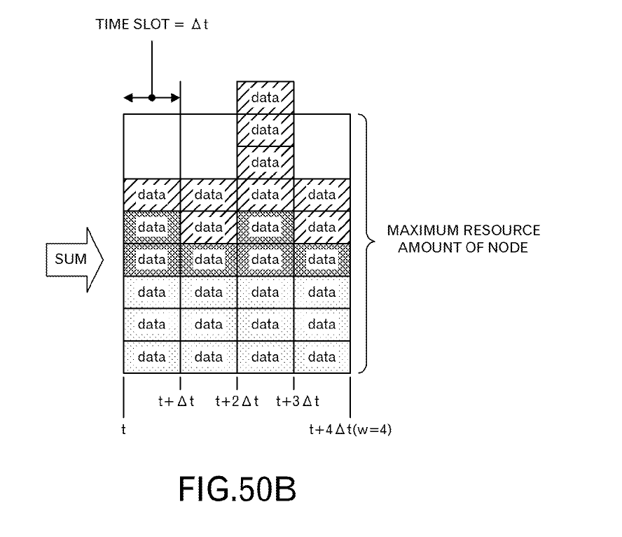

The processing described so far will be explained by using FIGS. 50A and 50B. In FIG. 50A, a case where scheduling requests are received from the nodes L to N is illustrated, and each of the scheduling requests includes data of the transmission schedule for 4 time slots. Here, when congestion for a communication path to the node L was detected at the step S217, a schedule included in the scheduling request from the node L is changed. Specifically, two data blocks (namely messages) in the first time slot moves to the third time slot.

When such transmission schedules are piled up for each time slot, a state illustrated in FIG. 50B is obtained. In this example, 6 data blocks that are less than the reception resource are allocated to the first time slot, 6 data blocks that are less than the reception resources are allocated to the second time slot, 9 data blocks that exceed the reception resources are allocated to the third time slot, and 6 data blocks that are less than the reception resources are allocated to the fourth time slot. Data representing such a state is stored in the data format as illustrated in FIGS. 12 and 13.

Returning to the explanation of FIG. 49, when the number of messages that will be transmitted in each time slot is within the range of the reception resources (step S225: Yes route), the second scheduler 109 sends schedule notification including contents of scheduling requests stored in the scheduling data storage unit 111 to each requesting source node (step S227). However, schedule notification including a changed schedule is transmitted to a transmission source node in which the processing of the step S219 was executed.

Then, the second scheduler 109 stores contents of the scheduling notification in the scheduling data storage unit 111 (step S229). Moreover, the second scheduler 109 discards each scheduling request that was received this time (step S231).

On the other hand, when the number of messages in one or more of the time slots exceeds the range of the reception resources (step S225: No route), the processing shifts to the processing of FIG. 23 through the terminal A. Because the processing after the terminal A has been explained in the first embodiment, the explanation of the processing after the terminal A is omitted here.

By executing the processing as described above, it becomes possible to prevent delay of data transmission from occurring even when detecting congestion in a transmission destination node.

### Embodiment 5

In the fifth embodiment, a method to reset transmission schedule for plural related data blocks in a batch will be explained.

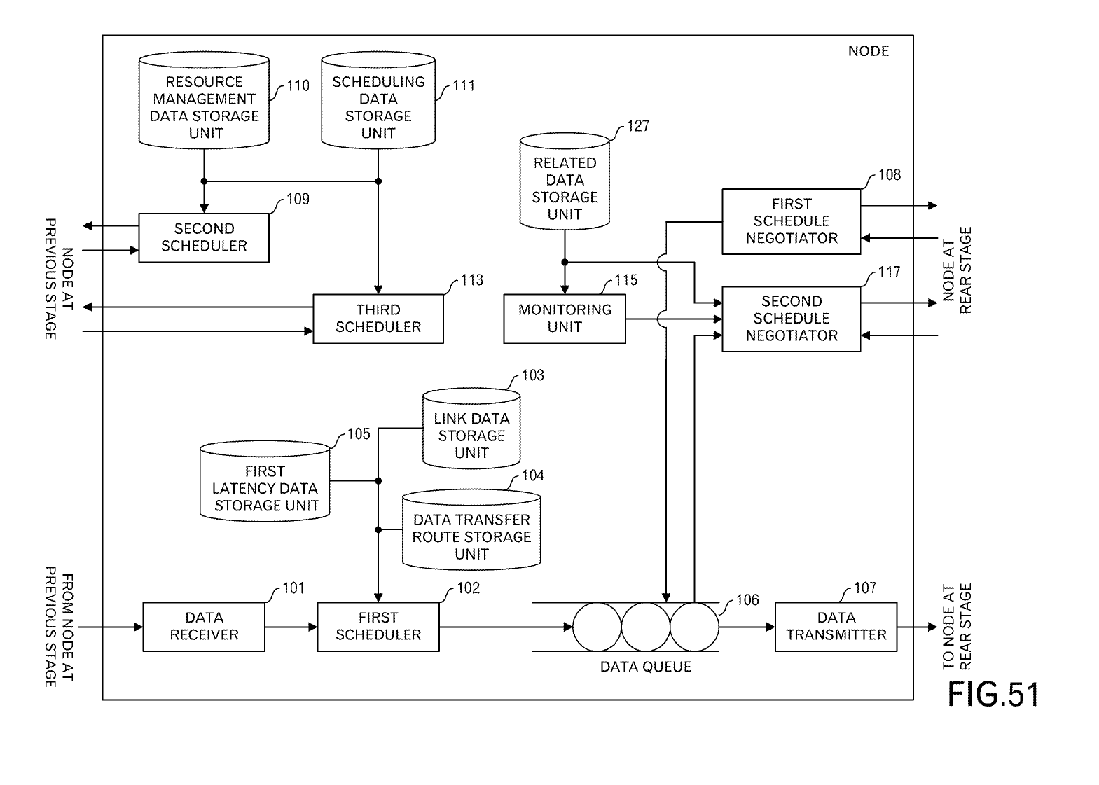

FIG. 51 illustrates a configuration example of the nodes A to C relating to the fifth embodiment. The node includes the data receiver 101, the first scheduler 102, the link data storage unit 103, the data transfer route storage unit 104, the first latency data storage unit 105, the data queue 106, the data transmitter 107, the first schedule negotiator 108, the second scheduler 109, the resource management data storage unit 110, the scheduling data storage unit 111, the third scheduler 113, the monitoring unit 115, the second schedule negotiator 117, and a related data storage unit 127.

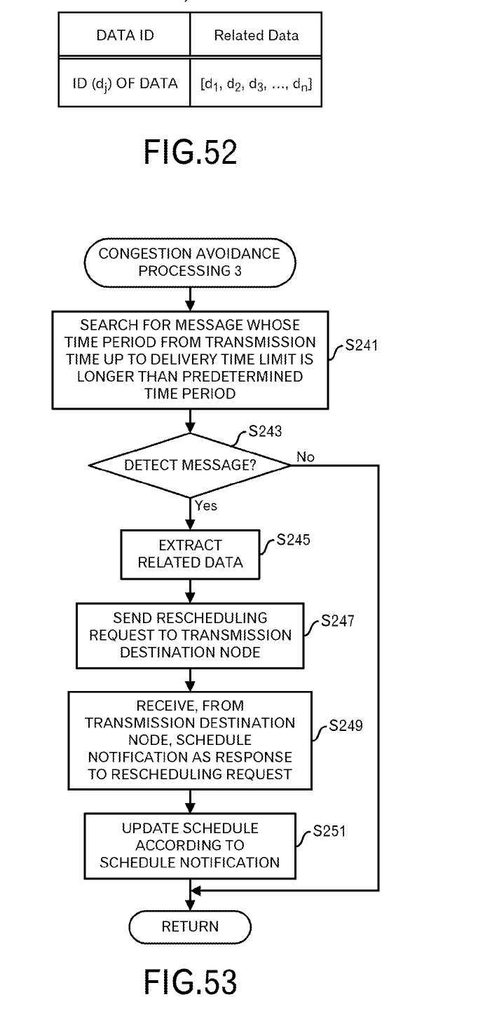

FIG. 52 illustrates an example of data stored in the related data storage unit 127. In the example of FIG. 52, an ID of data and data representing an ID of related data (that is related to the data) as an array are stored.

Next, the congestion avoidance processing in the fifth embodiment will be explained by using FIG. 53.

Firstly, the second schedule negotiator 117 searches messages that will be transmitted in the present time slot for a message whose time between a transmission time to a delivery time limit t_{lim,j} is longer than a predetermined time period (FIG. 53: step S241). The transmission time is an end time of the present time slot, for example.

The second schedule negotiator 117 determines whether a message has been detected at the step S241 (step S243). When the message has not been detected (step S243: No route), the processing returns to the calling-source processing.

On the other hand, when the message has been detected (step S243: Yes route), the second schedule negotiator 117 extracts, from the related data storage unit 127, an ID of data that is related to data relating to the detected message (step S245).

The second schedule negotiator 117 reads out the data (except data body itself) of the detected message and related data (except data body itself) of the data, and generates a rescheduling request. A data format of the rescheduling request is the same as the data format of the scheduling request, which is illustrated in FIG. 17. Then, the second schedule negotiator 117 sends the rescheduling request to the transmission destination node of the detected message (step S247). Because the processing executed by a node that received the rescheduling request has been explained in the first embodiment, the explanation of the processing is omitted here.

The second schedule negotiator 117 receives schedule notification including a schedule result from a transmission destination node (step S249). A data format of schedule notification received as a response to a rescheduling request is the format as illustrated in FIGS. 17 and 18.

Then, when the second schedule negotiator 117 receives the schedule notification, the second schedule negotiator 117 updates, according to the schedule notification, the transmission schedule data of the detected message, which is registered in the data queue 106 (step S251). Then, the processing returns to the calling-source processing.

By executing the processing as described above, for example, if there is a limit such that a destination next node cannot start processing without receiving plural related data blocks, it becomes possible to prevent the transmission destination node from waiting in a state where a part of the plural related data blocks was received.

Although one embodiment of this invention was explained above, this invention is not limited to those. For example, the functional block configuration of the node, which is explained above, does not always correspond to actual program module configurations.

Moreover, the configuration of the aforementioned data storing configuration is a mere example, and may be changed. Furthermore, as for the processing flow, as long as the processing results do not change, the turns of the steps may be exchanged or the steps may be executed in parallel.

For example, although information on degrees of priority is exchanged in the third embodiment, each node may change a degree of priority according to a rule defined in advance to prevent unevenness of allocation of degrees of priority.

Moreover, when executing the processing after the terminal A in the fourth embodiment, destination of the data blocks may be limited only to the time slots after the present time slot in order to avoid scheduling that will cause increase of congestion.

Moreover, in the scheduling for avoidance of congestion, a time slot which is a target of message detection may not be limited to a present time slot. If it is effective for removing congestion, for example, a message may be detected from a next time slot of the present time slot.

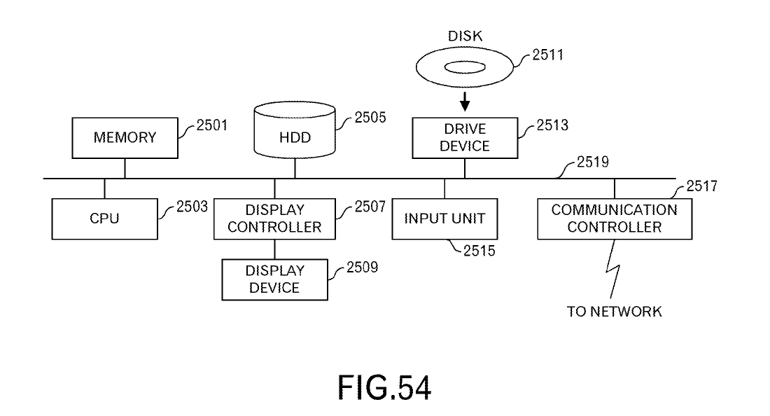

In addition, the aforementioned node is a computer device as illustrated in FIG. 54. That is, a memory 2501 (storage device), a CPU 2503 (processor), a hard disk drive (HDD) 2505, a display controller 2507 connected to a display device 2509, a drive device 2513 for a removable disk 2511, an input unit 2515, and a communication controller 2517 for connection with a network are connected through a bus 2519 as illustrates in FIG. 54. An operating system (OS) and an application program for carrying out the foregoing processing in the embodiment, are stored in the HDD 2505, and when executed by the CPU 2503, they are read out from the HDD 2505 to the memory 2501. As the need arises, the CPU 2503 controls the display controller 2507, the communication controller 2517, and the drive device 2513, and causes them to perform necessary operations. Besides, intermediate processing data is stored in the memory 2501, and if necessary, it is stored in the HDD 2505. In these embodiments of this technique, the application program to realize the aforementioned functions is stored in the computer-readable, non-transitory removable disk 2511 and distributed, and then it is installed into the HDD 2505 from the drive device 2513. It may be installed into the HDD 2505 via the network such as the Internet and the communication controller 2517. In the computer as stated above, the hardware such as the CPU 2503 and the memory 2501, the OS and the necessary application programs systematically cooperate with each other, so that various functions as described above in details are realized.

The aforementioned embodiment is summarized as follows:

A data transmission method relating to this embodiment includes: (A) detecting that congestion has occurred in a network between the first information processing apparatus and a second information processing apparatus that is a transmission destination of one or more data blocks; (B) first identifying a first data block that satisfies a condition that a time period from a transmission time to a time limit of delivery is longer than a predetermined time period, based on data stored in a data storage unit that stores a transmission time and a time limit of delivery for each of the one or more data blocks; (C) first transmitting, to the second information processing apparatus, a first request that includes a time limit of delivery of the first data block and requests to reset a transmission time of the first data block; and (D) first receiving, from the second information processing apparatus, a transmission time that is set by the second information processing apparatus.

By performing processing as described above, it becomes possible to shift a transmission time of a data block when congestion has occurred, and it becomes possible to prevent delay of data transmission from occurring.

Moreover, the detecting may include: (a1) calculating a transmission rate from a decrease rate of a total size of the one or more data blocks; and (a2) determining that the congestion has occurred in the network, upon detecting that the calculated transmission rate is less than a first threshold value. By performing processing as described above, it becomes possible to properly find that the congestion has occurred in the network.

Moreover, the detecting may include: (a3) determining whether a latency between the first information processing apparatus and the second information processing apparatus exceeds a second threshold; and (a4) determining that the congestion has occurred in the network, upon determining that the latency between the first information processing apparatus and the second information processing apparatus exceeds the second threshold. By performing processing as described above, it becomes possible to properly find the congestion occurred in the network.

Moreover, the transmission time that is set by the second information processing apparatus may be set based on the time limit of delivery of the first data block and reception resources of the second information processing apparatus. By performing processing as described above, it becomes possible to avoid expiration of a delivery time limit and lack of reception resources in an information processing apparatus that is a destination.

Moreover, the data transmission method may further include: (E) second transmitting, to a third information processing apparatus that belongs to a same group as the first information processing apparatus, a first degree of priority allocated to the first information processing apparatus, upon detecting that the congestion has occurred in the network; (F) determining whether the first information processing apparatus receives a second degree of priority that is lower than the first degree of priority from the third information processing apparatus. And, the first transmitting may include: (c1) transmitting the first request to the second information processing apparatus, upon determining that the first information processing apparatus does not receive the second degree of priority or the first information processing apparatus receives the second degree of priority that is lower than the first degree of priority. By performing processing as described above, even if congestion has occurred, a case where the first request is not transmitted occurs. Therefore, it becomes possible to suppress unnecessary reset.

Moreover, the data transmission method may further include: (G) second identifying a status of congestion in a second network between the first information processing apparatus and a fourth information processing apparatus that transmits one or plural data blocks to the first information processing apparatus; (H) second receiving, from the fourth information processing apparatus, a second request to set transmission times of the one or the plural data blocks; (I) setting the transmission times of the one or the plural data blocks, based on reception resources of the first information apparatus and the identified status of the congestion in the second network; and (J) second transmitting the set transmission times of the one or the plural data blocks to the fourth information processing apparatus. By performing processing as described above, it becomes possible to receive data without congestion. Moreover, it becomes possible to avoid lack of reception resources.

Moreover, the data transmission method may further include: (K) extracting a related data block that is related to the first data block by using a second data storage unit that stores, for each of the one or more data blocks, an identifier of a related data block that is related to the data block. And the first request may be a request to reset transmission times of the first data block and the extracted data block. By performing processing as described above, it becomes possible to perform reset for plural related data blocks in a batch.

Incidentally, it is possible to create a program causing a computer to execute the aforementioned processing, and such a program is stored in a computer readable storage medium or storage device such as a flexible disk, CD-ROM, DVD-ROM, magneto-optic disk, a semiconductor memory such as ROM (Read Only Memory), and hard disk. In addition, the intermediate processing result is temporarily stored in a storage device such as a main memory or the like.

All examples and conditional language recited herein are intended for pedagogical purposes to aid the reader in understanding the invention and the concepts contributed by the inventor to furthering the art, and are to be construed as being without limitation to such specifically recited examples and conditions, nor does the organization of such examples in the specification relate to a showing of the superiority and inferiority of the invention. Although the embodiments of the present inventions have been described in detail, it should be understood that the various changes, substitutions, and alterations could be made hereto without departing from the spirit and scope of the invention.

What is claimed is:

1. Anon-transitory computer-readable storage medium storing a program for causing a first information processing apparatus to execute a process, the process comprising:
detecting that congestion has occurred in a network between the first information processing apparatus and a second information processing apparatus that is a transmission destination of one or more data blocks;
first identifying a first data block that satisfies a condition that a time period from a transmission time to a time limit of delivery is longer than a predetermined time period, based on data stored in a data storage unit that stores a transmission time and a time limit of delivery for each of the one or more data blocks;
first transmitting, to the second information processing apparatus, a first request that includes a time limit of delivery of the first data block and requests to reset a transmission time of the first data block; and
first receiving, from the second information processing apparatus, a transmission time that is set by the second information processing apparatus.

2. The non-transitory computer-readable storage medium as set forth in claim 1, wherein the detecting comprises:
calculating a transmission rate from a decrease rate of a total size of the one or more data blocks; and
determining that the congestion has occurred in the network, upon detecting that the calculated transmission rate is less than a first threshold value.

3. The non-transitory computer-readable storage medium as set forth in claim 1, wherein the detecting comprises:
determining whether a latency between the first information processing apparatus and the second information processing apparatus exceeds a second threshold; and
determining that the congestion has occurred in the network, upon determining that the latency between the first information processing apparatus and the second information processing apparatus exceeds the second threshold.

4. The non-transitory computer-readable storage medium as set forth in claim 1, wherein the transmission time that is set by the second information processing apparatus is set based on the time limit of delivery of the first data block and reception resources of the second information processing apparatus.

5. The non-transitory computer-readable storage medium as set forth in claim 1, further comprising:
second transmitting, to a third information processing apparatus that belongs to a same group as the first information processing apparatus, a first degree of priority allocated to the first information processing apparatus, upon detecting that the congestion has occurred in the network;
determining whether the first information processing apparatus receives a second degree of priority that is lower than the first degree of priority from the third information processing apparatus, and
wherein the first transmitting comprises:
transmitting the first request to the second information processing apparatus, upon determining that the first information processing apparatus does not receive the second degree of priority or the first information processing apparatus receives the second degree of priority that is lower than the first degree of priority.

6. The non-transitory computer-readable storage medium as set forth in claim 1, further comprising:
second identifying a status of congestion in a second network between the first information processing apparatus and a fourth information processing apparatus that transmits one or a plurality of data blocks to the first information processing apparatus;
second receiving, from the fourth information processing apparatus, a second request to set transmission times of the one or the plurality of data blocks;
setting the transmission times of the one or the plurality of data blocks, based on reception resources of the first information apparatus and the identified status of the congestion in the second network; and
second transmitting the set transmission times of the one or the plurality of data blocks to the fourth information processing apparatus.

7. The non-transitory computer-readable storage medium as set forth in claim 1, further comprising:
extracting a related data block that is related to the first data block by using a second data storage unit that stores, for each of the one or more data blocks, an identifier of a related data block that is related to the data block, and
wherein the first request is a request to reset transmission times of the first data block and the extracted data block.

8. A data transmission method, comprising:
detecting, by using a computer, congestion in a network between the first information processing apparatus and a second information processing apparatus that is a transmission destination of one or more data blocks;
first identifying, by using the computer, a first data block that satisfies a condition that a time period from a transmission time to a time limit of delivery is longer than a predetermined time period, based on data stored in a data storage unit that stores a transmission time and a time limit of delivery for each of the one or more data blocks;
first transmitting, by using the computer and to the second information processing apparatus, a first request that includes a time limit of delivery of the first data block and requests to reset a transmission time of the first data block; and
first receiving, by using the computer and from the second information processing apparatus, a transmission time that is set by the second information processing apparatus.

9. The data transmission method as set forth in claim 8, wherein the detecting comprises:
calculating a transmission rate from a decrease rate of a total size of the one or more data blocks; and
determining that the congestion has occurred in the network, upon detecting that the calculated transmission rate is less than a first threshold value.

10. The data transmission method as set forth in claim 8, wherein the detecting comprises:
determining whether a latency between the first information processing apparatus and the second information processing apparatus exceeds a second threshold; and
determining that the congestion has occurred in the network, upon determining that the latency between the first information processing apparatus and the second information processing apparatus exceeds the second threshold.

11. The data transmission method as set forth in claim 8, wherein the transmission time that is set by the second information processing apparatus is set based on the time limit of delivery of the first data block and reception resources of the second in formation processing apparatus.

12. The data transmission method as set forth in claim 8, further comprising:
second transmitting, by using the computer and to a third information processing apparatus that belongs to a same group as the first information processing apparatus, a first degree of priority allocated to the first information processing apparatus, upon detecting that the congestion has occurred in the network;
determining, by using the computer, whether the first information processing apparatus receives a second degree of priority that is lower than the first degree of priority from the third information processing apparatus, and
wherein the first transmitting comprises:
transmitting the first request to the second information processing apparatus, upon determining that the first information processing apparatus does not receive the second degree of priority or the first information processing apparatus receives the second degree of priority that is lower than the first degree of priority.

13. The data transmission method as set forth in claim 8, further comprising:
second identifying, by using the computer, a status of congestion in a second network between the first information processing apparatus and a fourth information processing apparatus that transmits one or a plurality of data blocks to the first information processing apparatus;
second receiving, by using the computer and from the fourth information processing apparatus, a second request to set transmission times of the one or the plurality of data blocks;
setting, by using the computer and the transmission times of the one or the plurality of data blocks, based on reception resources of the first information apparatus and the identified status of the congestion in the second network; and
second transmitting, by using the computer, the set transmission times of the one or the plurality of data blocks to the fourth information processing apparatus.

14. The data transmission method as set forth in claim 8, further comprising:
extracting, by using the computer, a related data block that is related to the first data block by using a second data storage unit that stores, for each of the one or more data blocks, an identifier of a related data block that is related to the data block, and
wherein the first request is a request to reset transmission times of the first data block and the extracted data block.

15. An information processing apparatus, comprising:
a memory; and
a processor configured to use the memory and execute a process, the process comprises
detecting congestion has occurred in a network between the first information processing apparatus and a second information processing apparatus that is a transmission destination of one or more data blocks;
first identifying a first data block that satisfies a condition that a time period from a transmission time to a time limit of delivery is longer than a predetermined time period, based on data stored in a data storage unit that stores a transmission time and a time limit of delivery for each of the one or more data blocks;
first transmitting, to the second information processing apparatus, a first request that includes a time limit of delivery of the first data block and requests to reset a transmission time of the first data block; and
first receiving, from the second information processing apparatus, a transmission time that is set by the second information processing apparatus.

16. The information processing apparatus as set forth in claim 15, wherein the detecting comprises:
calculating a transmission rate from a decrease rate of a total size of the one or more data blocks; and
determining that the congestion has occurred in the network, upon detecting that the calculated transmission rate is less than a first threshold value.

17. The information processing apparatus as set forth in claim 15, wherein the detecting comprises:
determining whether a latency between the first information processing apparatus and the second information processing apparatus exceeds a second threshold; and
determining that the congestion has occurred in the network, upon determining that the latency between the first information processing apparatus and the second information processing apparatus exceeds the second threshold.

18. The information processing apparatus as set forth in claim 15, wherein the transmission time that is set by the second information processing apparatus is set based on the time limit of delivery of the first data block and reception resources of the second information processing apparatus.

19. The information processing apparatus as set forth in claim 15, wherein the process further comprises:
second transmitting, to a third information processing apparatus that belongs to a same group as the first information processing apparatus, a first degree of priority allocated to the first information processing apparatus, upon detecting that the congestion has occurred in the network;
determining whether the first information processing apparatus receives a second degree of priority that is lower than the first degree of priority from the third information processing apparatus, and
wherein the first transmitting comprises:
transmitting the first request to the second information processing apparatus, upon determining that the first information processing apparatus does not receive the second degree of priority or the first information processing apparatus receives the second degree of priority that is lower than the first degree of priority.

20. The information processing apparatus as set forth in claim 15, wherein the process further comprises:
second identifying a status of congestion in a second network between the first information processing apparatus and a fourth information processing apparatus that transmits one or a plurality of data blocks to the first information processing apparatus;
second receiving, from the fourth information processing apparatus, a second request to set transmission times of the one or the plurality of data blocks;
setting the transmission times of the one or the plurality of data blocks, based on reception resources of the first information apparatus and the identified status of the congestion in the second network; and
second transmitting the set transmission times of the one or the plurality of data blocks to the fourth information processing apparatus.
